(19) United States
(12) Patent Application Publication
(10) Pub. No.: US 2019/0050781 A1
(43) Pub. Date: Feb. 14, 2019

(54) PERFORMANCE EVALUATION METHOD

(71) Applicant: PERFORMANCE LEARNING SYSTEMS, INC., Buffalo, NY (US)

(72) Inventors: Michael HORNING, JR., Williamsville, NY (US); James HOYER, Orefield, PA (US); David QUINN-JACOBS, Ithaca, NY (US)

(21) Appl. No.: 15/674,807

(22) Filed: Aug. 11, 2017

(51) Int. Cl. G06Q 10/06; G06Q 10/10

(52) U.S. Cl. CPC G06Q 10/06398; G06Q 10/10

(57) ABSTRACT

A computer-implemented evaluation method for evaluating an employee includes providing an evaluation dashboard application to participants capable of generating a collective progress report indicating a proportion of group members who have transmitted external-evaluation information at a time the collective progress report is generated, and further capable of generating a plurality of individual progress reports respectively indicating a completeness of external-evaluation information received from each of the plurality of group members at a time the plurality of individual progress reports are generated. The collective progress report and the plurality of individual progress reports are accessible by each participant executing the evaluation dashboard application on a remote computer without communicating with another participant. A participant in the evaluation process can anonymously check on the progress of other participants in the evaluation process in real time.

### FIELD OF THE INVENTION

The present invention relates generally to methods for evaluating job performance of an employee or an independent contractor who has been hired to perform services. For example, the present invention may be used by a school district superintendent and a board of education of the school district to evaluate job performance of the superintendent.

### BACKGROUND OF THE INVENTION

In New York State and other states, each school board overseeing a respective school district is required by law to evaluate the performance of the superintendent of the school district on an annual basis. The requirement imposes a deadline on the school board to complete the evaluation. Superintendent evaluations by the school board are vital to maintaining a healthy and efficient leadership team.

The superintendent evaluation process has traditionally been a paper-based process in which the board president receives documents and other information submitted by the superintendent and the various board members, and supervises preparation of a consolidated written evaluation integrating the submitted evaluation information. Each of the participants in the process (i.e. the superintendent, the regular board members, and the board president) is typically unaware of the current or “real time” progress of the other participants. The school board president will know whether or not required evaluation materials have been received from other participants, and may have to remind participants to complete and submit required evaluation materials in a timely fashion so that that the evaluation process can remain on schedule. In addition, the board president may be responsible for keeping all submitted evaluation materials safe and confidential. If self-evaluation materials are submitted by the superintendent, the board president must efficiently disseminate those materials to the various regular board members. Consequently, paper-based superintendent evaluation processes are time-consuming, expensive, and inefficient.

### SUMMARY OF THE INVENTION

A computer-implemented method of conducting an evaluation of an employee by a plurality of group members including a group leader is described. The employee and the plurality of group members are “participants” in the evaluation method.

The computer implemented method includes providing an evaluation dashboard application to the participants for execution by each participant on one or more remote computers connected to a network. The method also includes providing a database server connected to the network, wherein the database server comprises a microprocessor and a memory configured to store evaluation information associated with the evaluation of the employee and participant information respectively associated with the participants. The participant information indicates a role of the associated participant chosen from the group of roles consisting of employee, regular group member, and group leader. The method additionally includes providing a hub server connected to the database server and the one or more remote computers via the network.

In a further step of the evaluation method, employee performance self-evaluation information is received at the hub server from the employee, wherein the self-evaluation information is transmitted to the hub server by the employee executing the evaluation dashboard application on a remote computer, and the self-evaluation information is stored as evaluation information by the database server. The method includes permitting each of the plurality of group members to access and review the self-evaluation information by executing the evaluation dashboard application on a remote computer, and receiving employee performance external-evaluation information at the hub server respectively from the plurality of group members. The external-evaluation information is transmitted to the hub server by the plurality of group members, respectively, executing the evaluation dashboard application on a remote computer, and the external-evaluation information is stored as evaluation information by the database server.

The method is characterized by the step of generating a collective progress report in the evaluation dashboard application, wherein the collective progress report indicates a proportion of group members who have transmitted external-evaluation information to the hub server at a time the collective progress report is generated. The method is further characterized by the step of generating a plurality of individual progress reports in the evaluation dashboard application, wherein the plurality of individual progress reports respectively indicate a completeness of external-evaluation information received at the hub server from each of the plurality of group members at a time the plurality of individual progress reports are generated. The collective progress report and the plurality of individual progress reports are accessible by each participant executing the evaluation dashboard application on a remote computer without communicating with another participant. Consequently, a participant can determine anonymously and in real time whether or not he or she is holding up the evaluation process.

### BRIEF DESCRIPTION OF THE DRAWING VIEWS

The nature and mode of operation of the present invention will now be more fully described in the following detailed description of the invention taken with the accompanying drawing figures, in which:

FIG. 1 is a schematic diagram of a network-based system for carrying out a computer-implemented employee evaluation method in accordance with an embodiment of the present invention;

FIG. 2 shows a main dashboard screen of an evaluation dashboard application used in an embodiment of the employee evaluation method of the present invention;

FIG. 3 shows a goal entry prompt of a goal entry screen accessed from the main dashboard screen shown in FIG. 2;

FIG. 4 is a view similar to that of FIG. 3, showing entry of a goal by an employee using the evaluation dashboard application;

FIG. 5 shows a goal entry confirmation displayed by the evaluation dashboard application when the goal entered in FIG. 4 is saved;

FIG. 6 shows the main dashboard screen of the evaluation dashboard application after the goal entered in FIG. 4 is saved;

FIG. 7 shows the main dashboard screen after an initial stage of submitting goals is marked completed;

FIG. 8 shows a self-evaluation entry prompt of a self-evaluation entry screen accessed from the main dashboard screen shown in FIG. 7, wherein the self-evaluation entry screen corresponds to a competency domain and the entry prompt corresponds to a specific competency within the domain;

FIG. 9 is a view similar to that of FIG. 8, showing entry of a self-grade and a self-reflection by the employee using the evaluation dashboard application;

FIG. 10 shows entry of another self-grade and self-reflection corresponding to another specific competency within the domain;

FIG. 11 shows the main dashboard screen of the evaluation dashboard application after entry of required self-evaluation information has been partially completed by the employee;

FIG. 12 shows the main dashboard screen of the evaluation dashboard application after all required self-evaluation information has been entered by the employee;

FIG. 13 shows a warning screen displayed by the evaluation dashboard application after the employee chooses to submit the entered self-evaluation information to group members responsible for reviewing the employee;

FIG. 14 shows the main dashboard screen of the evaluation dashboard application during review and evaluation of the employee by group members;

FIG. 15 shows a secondary screen of the evaluation dashboard application during review and external evaluation of the employee by group members;

FIG. 16 shows a prompt displayed to a group member when the group member begins entry of external-evaluation information, whereby the group member may choose to prepopulate the external-evaluation information with self-evaluation information submitted by the employee;

FIG. 17 shows an external-evaluation entry prompt of an external-evaluation entry screen allowing a group member to enter external-evaluation information, wherein the external-evaluation information is prepopulated with self-evaluation information submitted by the employee;

FIG. 18 is a view similar to that of FIG. 17, showing entry of a grade and a comment by the group member, wherein the grade and comment differ from the corresponding prepopulated self-grade and self-reflection submitted by the employee;

FIG. 19 is a view similar to that of FIG. 17, showing entry of a grade and a comment by the group member, wherein the grade is the same as the corresponding prepopulated self-grade submitted by the employee;

FIG. 20 shows entry of grades and comments by the group member for further specific competencies in a competency domain before proceeding to a next domain;

FIG. 21 shows external-evaluation entry prompts in the next competency domain, wherein the entry prompts are prepopulated with corresponding self-evaluation information submitted by the employee;

FIG. 22 shows completion of the entry of external-evaluation information by the group member, wherein the final competency domain comprises goals submitted by the employee;

FIG. 23 shows the secondary screen of the evaluation dashboard application during review and external evaluation of the employee by group members, wherein two of the group members have completed entering external-evaluation information, another of the group members is nearing completion, and the remaining group members have not started entering external-evaluation information;

FIG. 24 is a view similar to that of FIG. 17, wherein the external-evaluation information is not prepopulated with self-evaluation information submitted by the employee;

FIG. 25 shows the main dashboard screen of the evaluation dashboard application during review and external evaluation of the employee by group members, wherein completion status corresponds to that indicated in FIG. 23;

FIG. 26 is a view similar to that of FIG. 23, where the group leader is logged in and using the evaluation dashboard application;

FIG. 27 shows the main dashboard screen of the evaluation dashboard application as review and external evaluation of the employee by group members progresses further;

FIG. 28 is a close-up view of a completion status graphic displayed on the main dashboard screen shown in FIG. 27;

FIG. 29 is a view similar to that of FIG. 23, wherein three of the group members have completed entering external-evaluation information, another eight of the group members have started but not completed entering external-evaluation information, and the remaining two group members have not started entering external-evaluation information;

FIG. 30 is a view similar to those of FIGS. 17 and 24, wherein the group member has selected a “supporting evidence” icon to attach a file containing supporting evidence;

FIG. 31 is an evidence attachment screen displayed when the group member selects an ADD button shown in FIG. 30;

FIG. 32 shows the evidence attachment screen wherein a file is selected for attachment as supporting evidence in connection with one of the specific competencies;

FIG. 33 is a view similar to that of FIG. 30, wherein the group member has saved the file as an attachment;

FIG. 34 shows another iteration of the evidence attachment screen of the evaluation dashboard application;

FIG. 35 is a view similar to those of FIGS. 17 and 24, illustrating an EDIT button selectable by a group member to allow uploaded external-evaluation information to be edited;

FIG. 36 shows the main dashboard screen of the evaluation dashboard application after all group members have completed entering external-evaluation information;

FIG. 37 is a view similar to that of FIG. 36, wherein the group leader is logged in and has the option to mark the external-evaluation step completed;

FIG. 38 shows the secondary screen of the evaluation dashboard application when the group leader is logged in but has not yet marked the external-valuation step completed;

FIG. 39 shows a consolidated comparison screen available to the group leader through a VIEW DETAILS button of the secondary screen shown in FIG. 38;

FIG. 40 shows the main dashboard screen of the evaluation dashboard application, wherein the group leader is logged in and has marked the external-evaluation step completed;

FIG. 41 shows a consolidated comparison screen available to the group leader following completion of the external-evaluation step;

FIG. 42 shows a consolidated evaluation screen available to the group leader following completion of the external-evaluation step;

FIG. 43 is a view similar to that of FIG. 42, illustrating use of an EDIT button available to the group leader for editing the consolidated evaluation;

FIG. 44 shows the main dashboard screen of the evaluation dashboard application after the group leader has finalized the consolidated evaluation;

FIG. 45 shows an evaluation review screen providing the group leader and the employee an opportunity to add post-evaluation reflections and comments to the record prior to signing off on the employee evaluation;

FIG. 46 is a view similar to that of FIG. 45, wherein the employee has signed the employee evaluation but the group leader has not yet signed;

FIG. 47 shows the main dashboard screen of the evaluation dashboard application after the employee has signed the employee evaluation but before the group leader has signed the employee evaluation;

FIG. 48 is a view similar to that of FIG. 46, wherein the group leader has also signed the employee evaluation; and

FIG. 49 shows the main dashboard screen of the evaluation dashboard application after the group leader and employee have signed off on the employee evaluation and the employee evaluation process is completed.

### DETAILED DESCRIPTION OF THE INVENTION

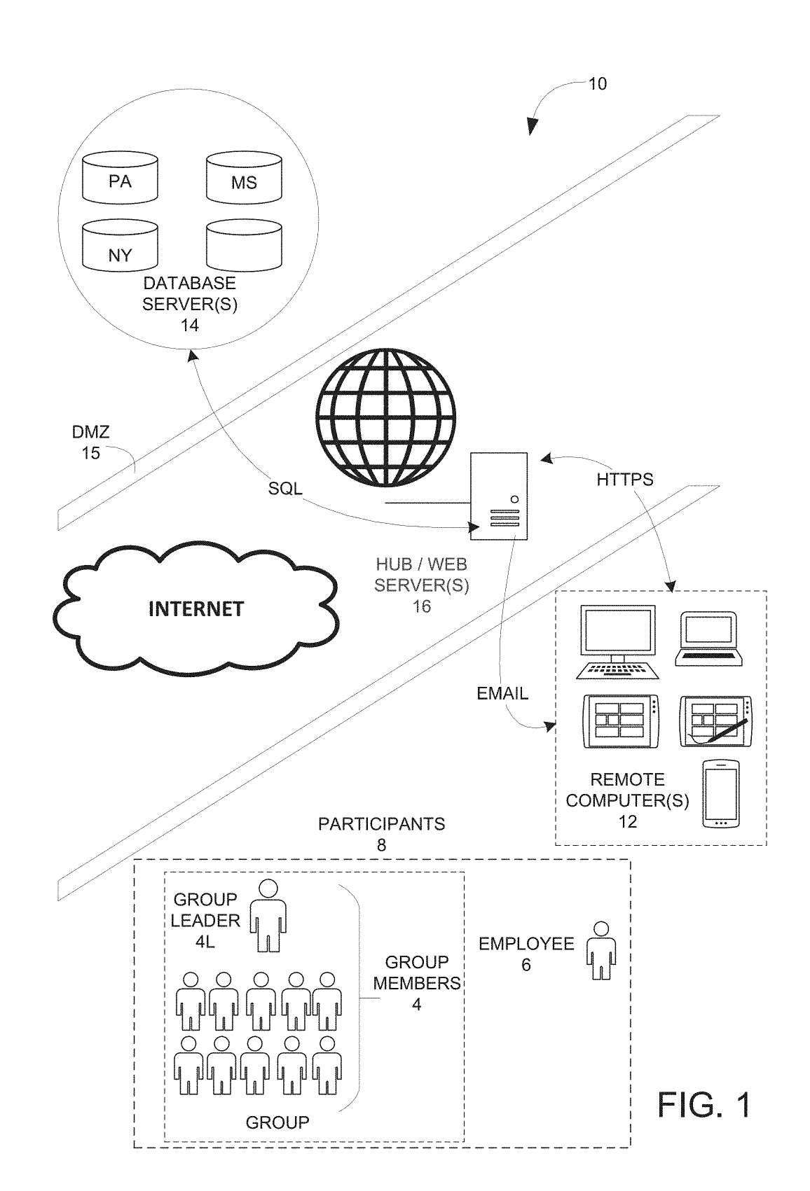

FIG. 1 illustrates basic architecture of a network-based computer system 10 on which a computer-implemented method of conducting an evaluation of an employee may be conducted in accordance with an embodiment of the present invention. The computer-implemented evaluation method may be used by a plurality of group members 4 including a group leader 4L to evaluate an employee 6, wherein the employee and the plurality of group members are all participants 8. The participants 8 have access to and may use remote computer(s) 12. The term “remote computer” is intended to broadly include desktop personal computers, laptop computers, tablet computers, person digital assistants, smart phones, and any computing device capable of running a browser program.

Network-based system 10 comprises one or more database servers 14 configured to store evaluation information associated with the evaluation of employee 6 and participant information respectively associated with each of the participants 8. The participant information indicates a role of the associated participant chosen from the group of roles consisting of employee, regular group member, and group leader, and may indicate further information such as identity, username, and password information.

Network-based system 10 may also comprise one or more hub servers 16. Hub server(s) 16 are connected by a network to communicate with database server(s) 14 and with remote computer(s) 12. For example, hub server(s) 16 may be Web servers connected to database server(s) 14 via the Internet and may communicate with remote computer(s) 12 via the World Wide Web on the Internet. Alternatively, hub server(s) 16 may be connected to communicate with database server(s) 14 and with remote computer(s) 12 via a Local Area Network (LAN) or Wide Area Network (WAN). Database server(s) 14 and hub server(s) 16 each include microprocessor(s), memory, and communications hardware configured to perform relevant server functions.

In the embodiment shown in FIG. 1, hub server(s) 16 are Web servers configured to process requests via Hypertext Transfer Protocol Secure (HTTPS) from remote computer(s) 12 and serve files to remote computer(s) 12 that form Web pages in response to the requests. Hub server(s) 16 may also be configured to act as email servers to allow email messages to be sent and received between and among participants 8 using remote computers 12. Hub server(s) 16 are connected to database server(s) 14 and may be configured to query data stored in database server(s) 14 using Structured Query Language (SQL). Database server(s) 14 may be provided within a “demilitarized zone” (DMZ) 15 or perimeter network for added data security. While FIG. 1 shows database server(s) 14 as being separate from hub server(s) 16, it is possible to provide database server(s) 14 and hub server(s) 16 as parts of the same server system.

Network-based computer system 10 is configured to host and provide an evaluation dashboard software application to participants 8 for execution by each participant on remote computer(s) 12. The evaluation dashboard application may be a Web-based application written in Hypertext Markup Language (HTML), JavaScript, or other Web-native language that is provided to remote computer(s) 12 and runs in a browser program on remote computer(s) 12. Alternatively, or in addition, the evaluation dashboard application may be a device native application. The evaluation dashboard application of the present invention is described in detail below with reference to user interface screens displayed to a participant 8 on a remote computer 12 during execution.

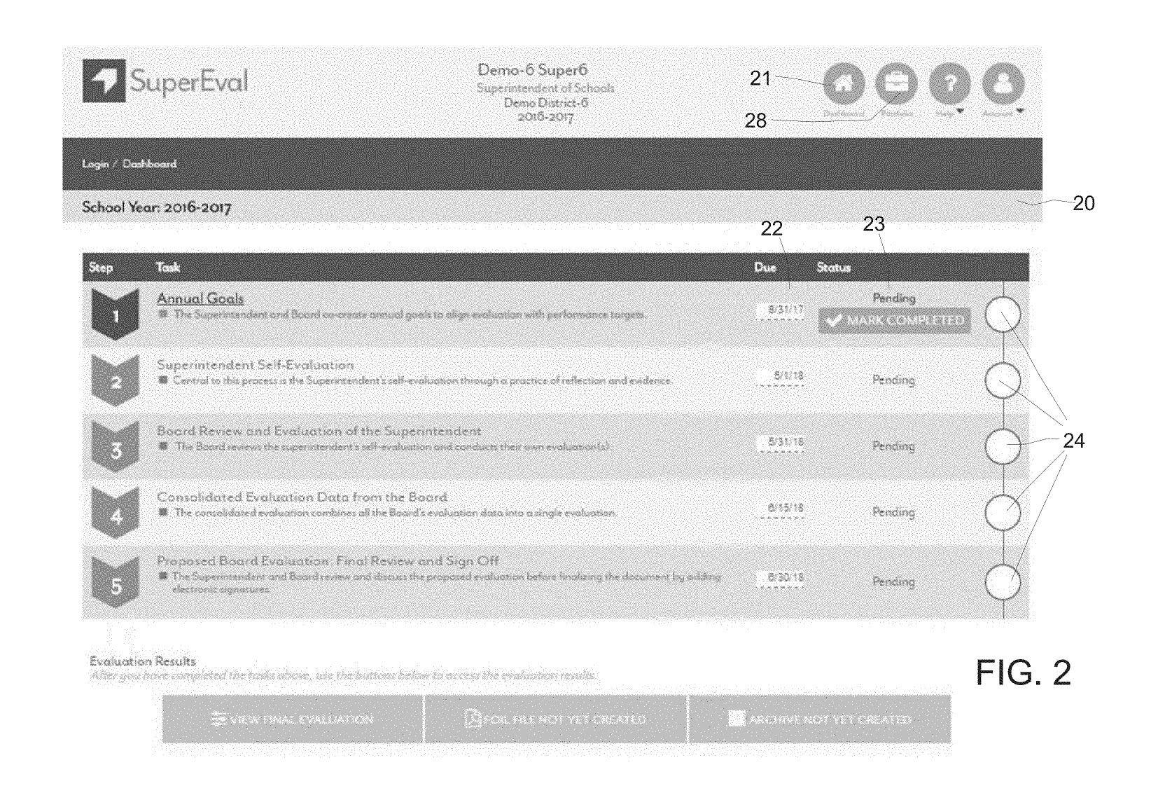

The evaluation dashboard application of the present invention is designed as a workflow application that guides workflow during the process of evaluating employee 6 from start to finish. In the present specification, the evaluation dashboard application is shown and described with reference to FIGS. 2 through 49 in the context of a school board charged with evaluating a superintendent hired by the board. In this context, the school board is the group made up of members 4, the school board president is the group leader 4L, and the superintendent is the employee 6. The term “employee” as used herein is meant in a broad sense to include traditional employees, independent contractors, and other individuals performing services for which the group desires to conduct an evaluation.

The various roles of participants 8 may be established during an initial installation and setup of the evaluation dashboard software application. An organizational administrator may be appointed to manage and update the participants and roles for a given organization. For example, if the organization is a school district, a district clerk may be given authorization to change the identity of the school superintendent, add and delete school board members as they join or leave the school board, and change the role of a board member to group leader if he or she is elected board president.

FIG. 2 shows a main dashboard screen 20 of the evaluation dashboard application. The evaluation dashboard application organizes the evaluation process into five main steps or stages of sequential workflow: 1) entry of annual goals of the employee, 2) self-evaluation of employee performance by the employee, 3) evaluation of the employee by the various group members, 4) consolidation of the evaluation data provided by the group members, and 5) finalization and presentation of the employee review to the employee by the group leader. Each step of the evaluation process must be completed before flow is permitted to proceed to the next step. Main dashboard screen 20 may include a due date column 22 indicating respective due dates assigned to each step of the evaluation process, a status column 23 a textual description of the completion status of each step of the evaluation process, and respective pie graphs 24 giving a visual representation of the completion status of each step.

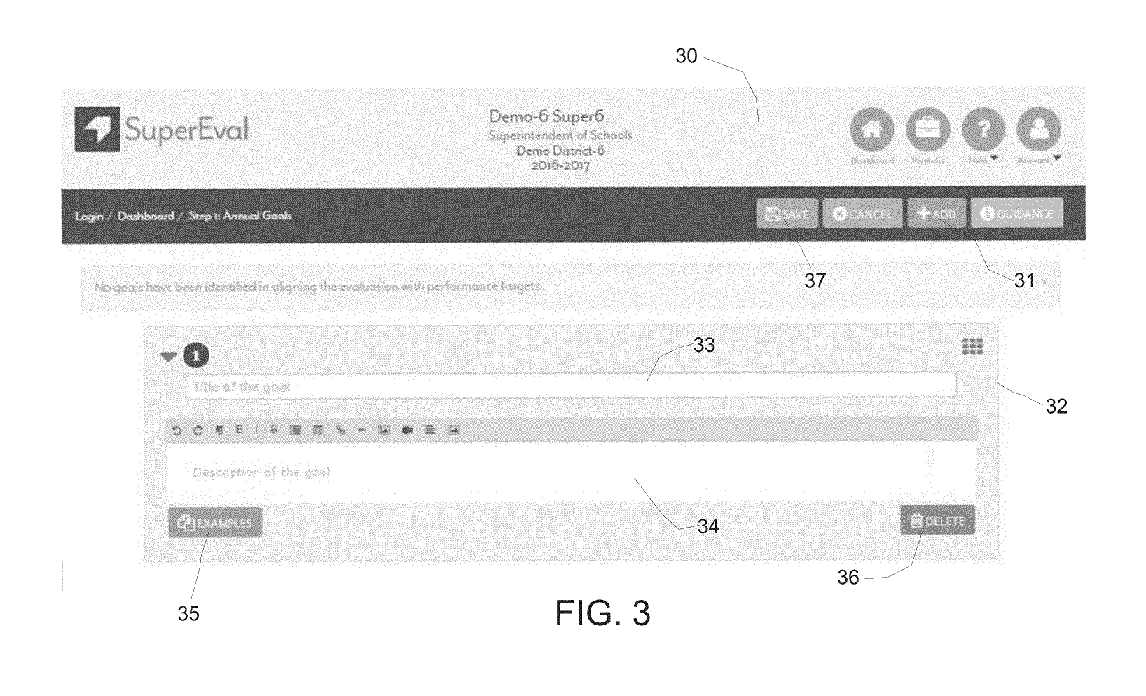

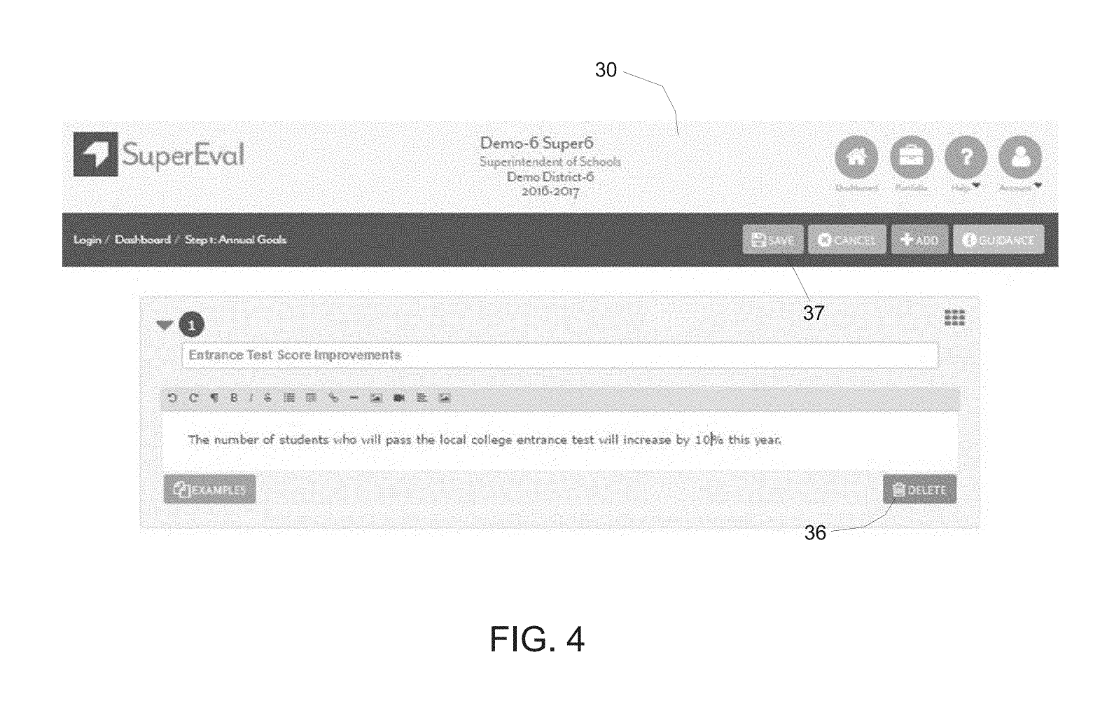

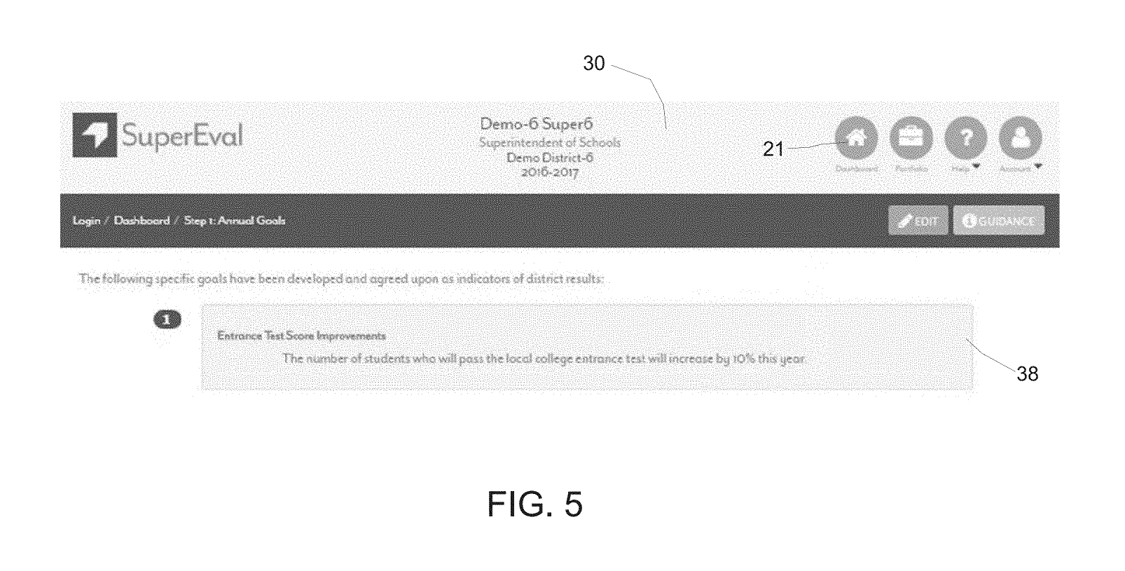

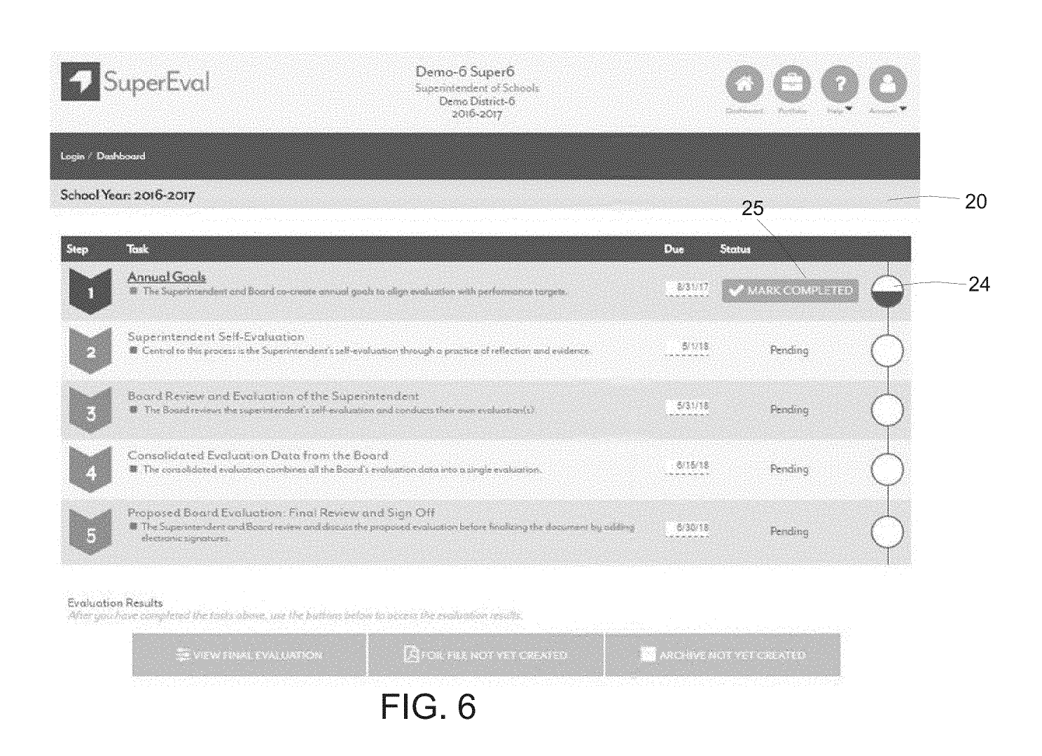

The first step of entering annual goals is undertaken by clicking Step 1 on main dashboard screen 20 to display a goal entry page 30 as shown in FIG. 3. Employee 6 is permitted to enter and edit goals, whereas group members 4, 4L may view entered goals but are not permitted to add or edit goals. Goal entry page 30 includes an ADD button 31 for adding a goal using a text entry sub-screen 32 having a first text field 33 for entering a title of the goal and a second text field 34 for entering a description of the goal. Example goals may be displayed and selected using an EXAMPLES button 35. FIG. 4 shows goal entry page 30 after a goal has been entered. The entered goal may be deleted by clicking a DELETE button 36. The goal may be saved by clicking a SAVE button 37. Once the entered goal is saved, text entry sub-screen 32 is replaced by a text box 38 displaying a confirmatory message indicating the saved goal, as shown in FIG. 5. The user may return to main dashboard screen 20 by clicking home icon 21. If employee 6 is logged in as the user, main dashboard screen 20 displays a step completion button 25 associated with the current step (e.g. Step 1) as shown in FIG. 6. After all goals are entered, the employee 6 may click step completion button 25 to signal that step one has been completed. It is also possible for the employee 6 to proceed to Step 2 without entering any goals in Step 1.

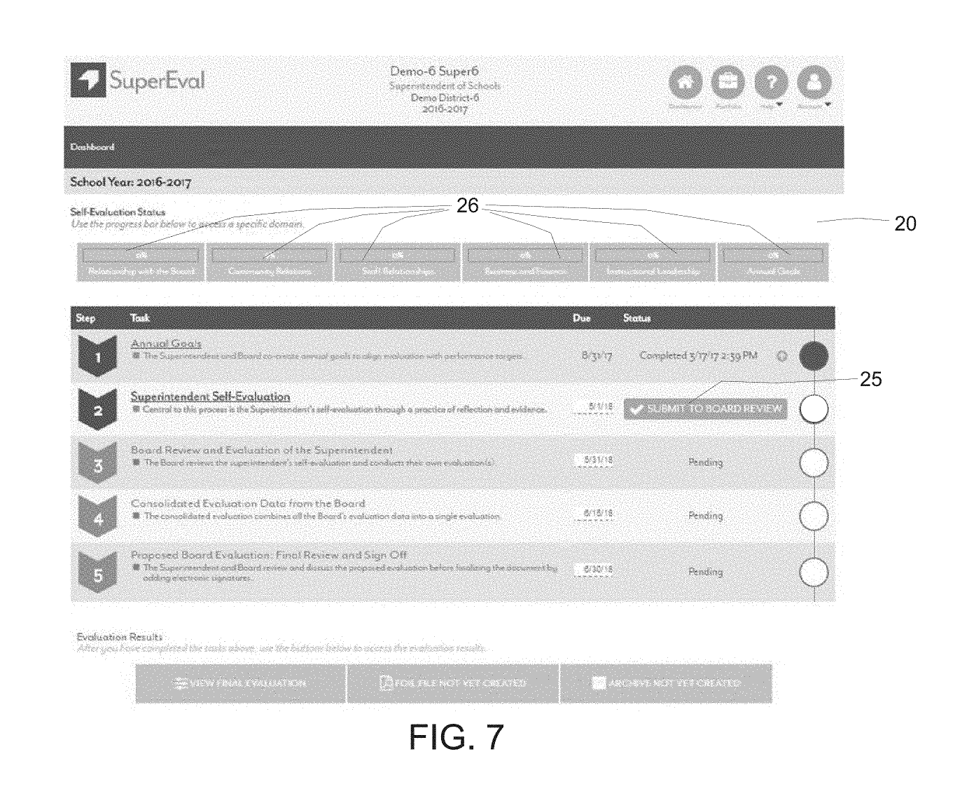

Reference is now made to FIG. 7, which shows main dashboard screen 20 at the outset of step two, employee self-evaluation. Both the self-evaluation in step two, and later external-evaluation by group members 4, 4L in step three, may follow a predefined rubric. For example, evaluation may rate the employee's performance with respect to various specified competencies that are grouped or categorized into a plurality of competency domains such that each competency domain includes at least one specified competency. In the context of a school superintendent evaluation, the domains may be, for example, Relationship with the Board, Community Relations, Staff Relationships, Business and Finance, Instructional Leadership. A further domain, Annual Goals, may be created if employee 6 has entered one or more goals in Step 1. In FIG. 7, a series of progress bars 26, one for each domain, are displayed to provide a graphic indication of the progress employee 6 is making in completing the self-evaluation step (step two).

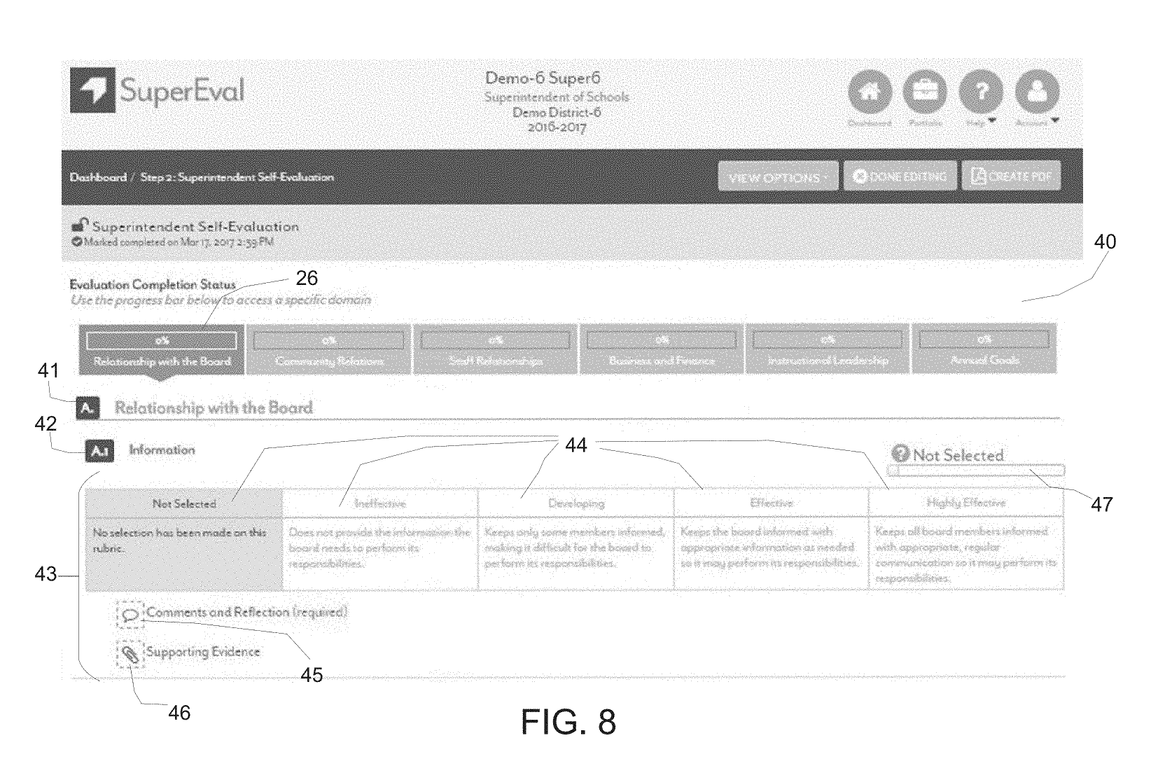

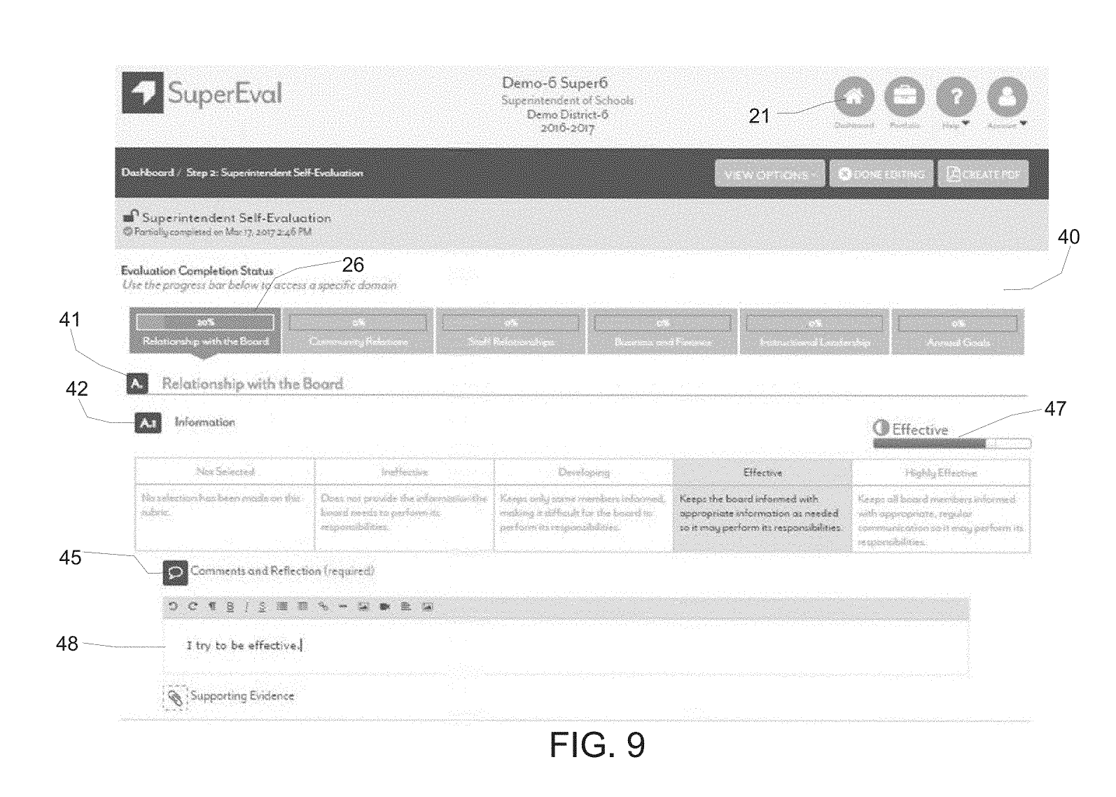

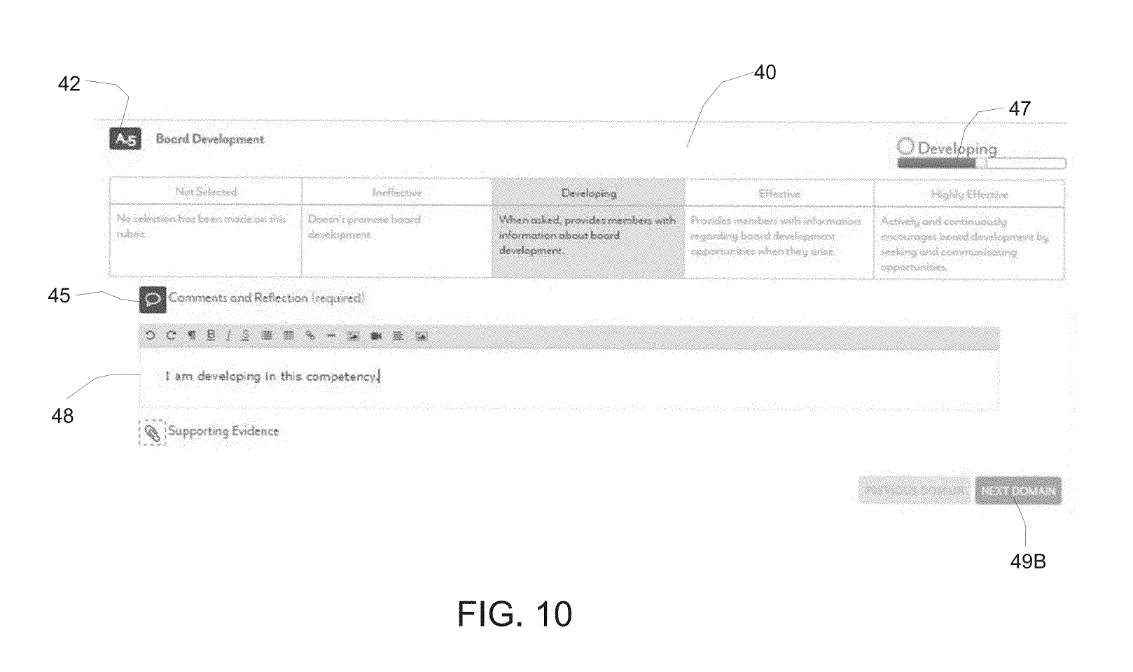

Within each domain, there are one or more competencies relevant to that domain. FIG. 8 shows a self-evaluation entry screen 40 accessed from the main dashboard screen 20 shown in FIG. 7 by clicking on one of the domain progress bars 26, in this case the “Relationship with the Board” domain progress bar. A first competency 42 within the domain 41 is “Information.” Associated with competency 42 is a self-evaluation entry prompt 43 including a plurality of predefined grades 44, a Comments and Reflections icon 45, a Supporting Evidence icon 46, and a selected grade indicator 47. In the example rubric described herein, predefined grades 44 selectable for each competency include “Ineffective,” “Developing,” “Effective,” and “Highly Effective.” The designation “Not Selected” is also available in the set of predefined grades 44 if a grade selection has not yet been selected. FIG. 9 illustrates selection of the grade “Effective” as a self-grade with respect to the first competency in the “Relationship with the Board” domain. The selection is reflected by selected grade indicator 47. In addition to selecting a self-grade for each competency, the employee 6 must enter a self-reflection. This is done by clicking Comments and Reflections icon 45 to display a text field 48 and entering text in the field as shown in FIG. 9. FIG. 10 illustrates entry of a self-grade and self-reflection for a final competency 42 (“Board Development”) within the “Relationship with the Board” domain 41. The user may click NEXT DOMAIN button 49B to proceed to the next domain, or may return to main dashboard screen 20 by scrolling up and clicking home icon 21 visible in FIG. 9.

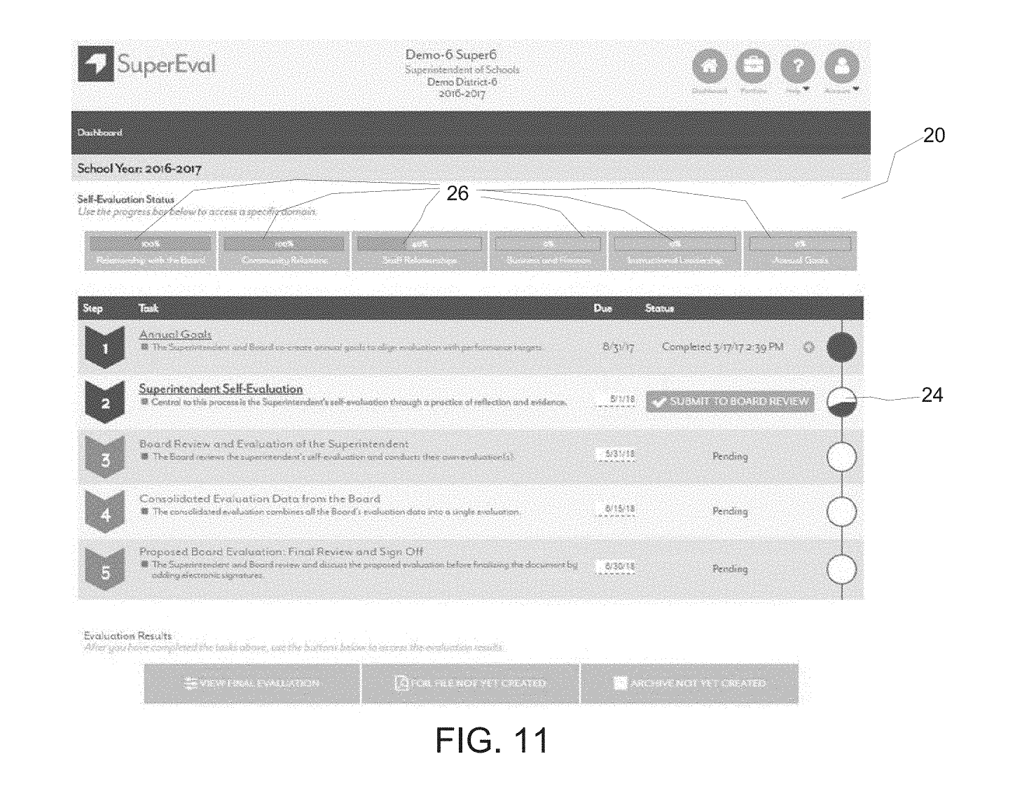

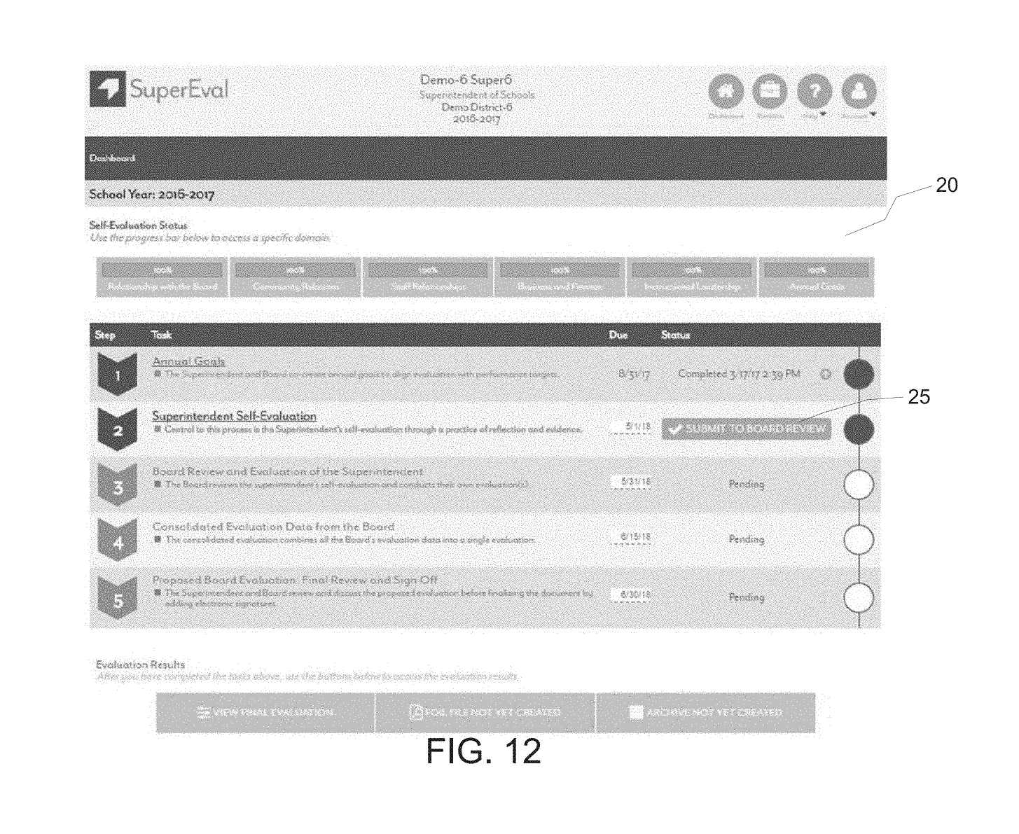

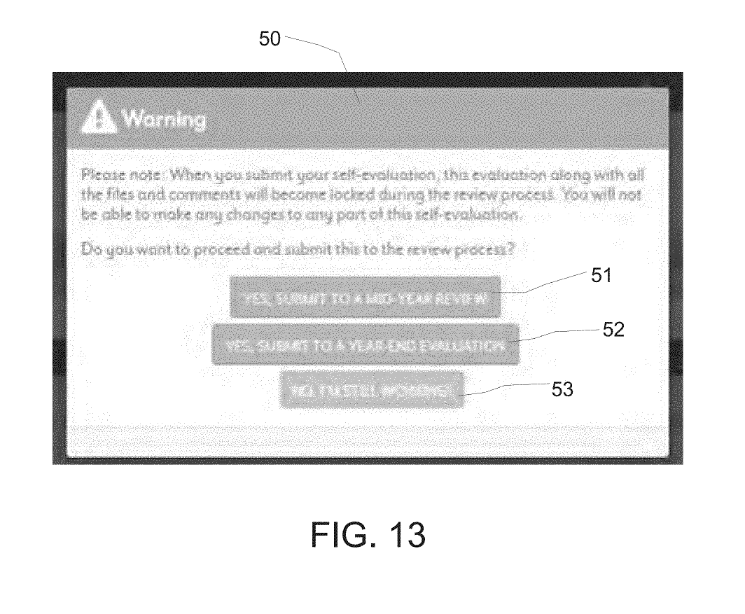

Progress during the self-evaluation step (step two) is indicated graphically on main dashboard screen 20 by corresponding pie graph 24 and progress bars 26 as shown in FIG. 11. FIG. 12 shows main dashboard screen 20 after employee 6 has entered self-grades and reflections for all competencies in all domains. Employee 6 may click step completion button 25 to indicate that step two has been completed. In the present embodiment, a warning message 50, shown in FIG. 13, is displayed when step completion button 25 is clicked to indicate completion of step two. Warning message 50 may remind employee 6 that submission of the self-evaluation information is final and information will no longer be editable after submission. Clickable submission buttons 51 and 52 may be provided for submitting the self-evaluation for mid-year review and year-end valuation, respectively. Another clickable button 53 allows the employee to go back and continue entering or editing self-evaluation information. Once the self-evaluation information is submitted by clicking either button 51 or 52, step two is completed and flow moves to step three.

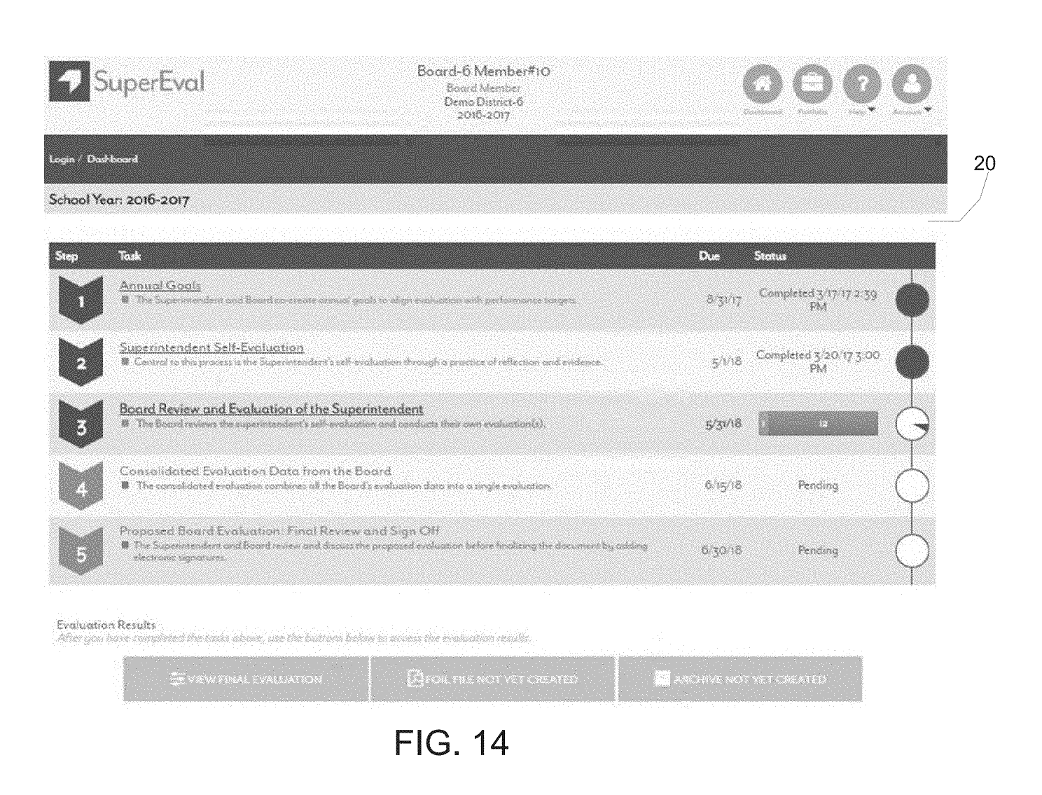

FIG. 14 shows main dashboard screen 20 at the outset of step three. During step three, the group members 4, 4L are permitted to access and review the self-evaluation information submitted by employee 6 by executing the evaluation dashboard application on a remote computer 12. Group members 4, 4L executing the evaluation dashboard application on a remote computer 12 are further permitted to upload external-evaluation information with respect to the employee's performance. The external-evaluation information transmitted by group members 4, 4L is received at a hub server 16 and is stored as evaluation information by a database server 14.

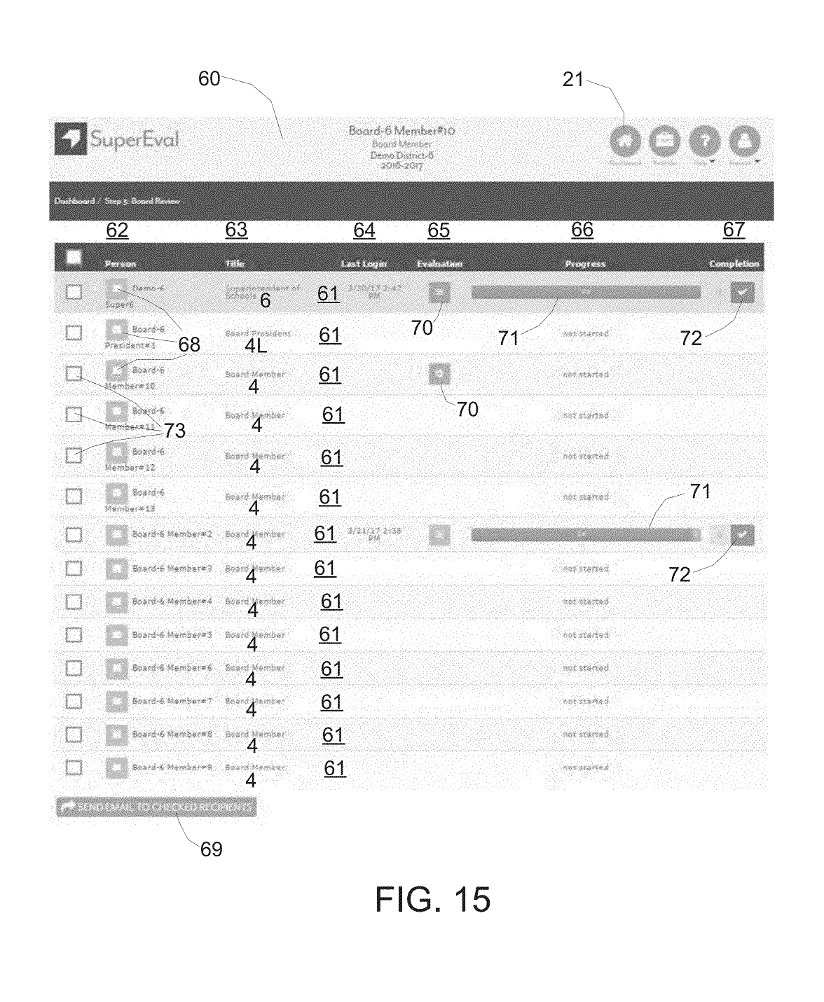

In the present embodiment, each group member 4, 4L may begin to enter and upload external-evaluation information by creating an evaluation. To create an evaluation, the group member clicks Step 3 on main dashboard screen 20 and a secondary screen 60 will be displayed as shown, for example, in FIG. 15. Secondary screen 60 includes a plurality of rows 61 respectively corresponding to the various participants 8. In the present example, the top row corresponds to the superintendent of schools (the employee 6), the second row corresponds to the school board president (the group leader 4L), and the remaining rows below correspond to various members of the school board (the group members 4). Each row contains information and control buttons related to the associated participant. In the illustrated embodiment, there is a column 62 identifying the participant, a column 63 providing the title of the participant, a column 64 indicating the date and time of the most recent login by the participant, a column 65 providing an active evaluation access button 70 where authorized, a column 66 in which an evaluation progress bar graph 71 is displayed, and a column 67 in which an evaluation completion indicator 72 is displayed with respect to evaluations that have already been started. A participant logged in to the valuation dashboard application can send an email directly to another participant by clicking the appropriate email button 68, or may send an email to a group of participants by checking corresponding boxes 73 and then clicking button 69 at the bottom of secondary screen 60.

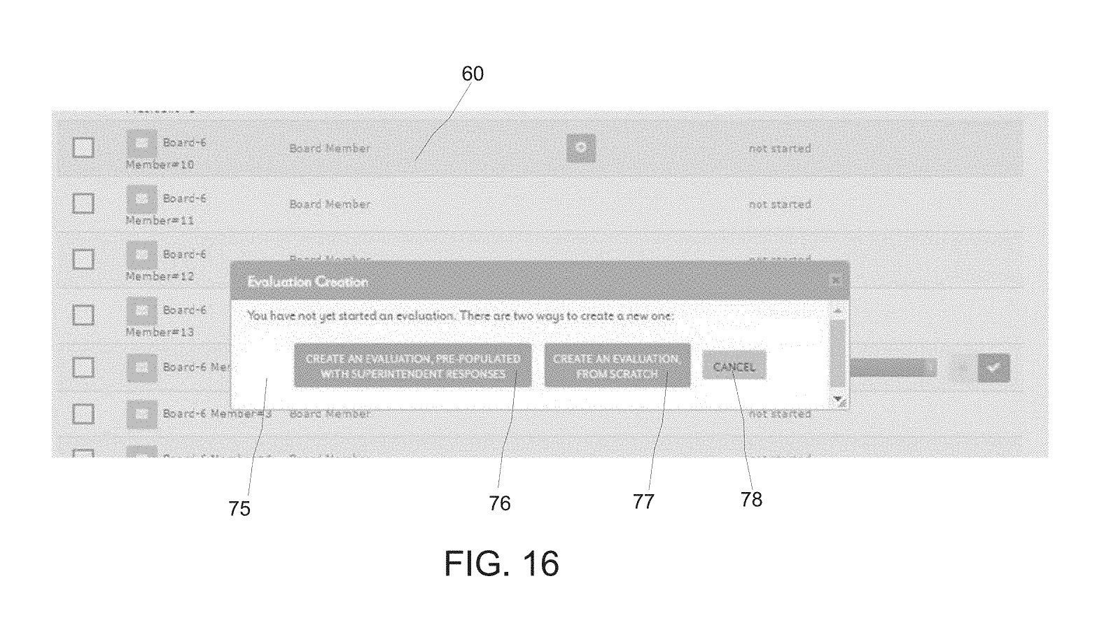

In the present example, Board Member #10 is logged in and may view but not edit the self-evaluation information previously uploaded by employee 6 (the superintendent of schools) by clicking evaluation access button 70 in the row 61 associated with the superintendent. Board Member #10 may also create an external-evaluation by clicking the evaluation access button 70 in his or her own row 61. When this is done, a pop-up prompt 75 is displayed over secondary screen 60 as shown in FIG. 16. Pop-up prompt 75 provides the participant with two choices, indicated by buttons 76 and 77, for creating an external-evaluation. The first choice according to button 76 is to create an external-evaluation using self-evaluation information already uploaded by employee 6. The external-evaluation uses the same predefined rubric followed in the self-evaluation of step two, described above. Button 76 gives the participant the option to prepopulate the external-evaluation rubric with the self-grades and reflections uploaded by employee 6 for all competencies in all domains. Alternatively, the participant may start the external-evaluation “from scratch” by selecting button 77. A cancel button 78 may be provided to allow the participant to return to secondary screen 60.

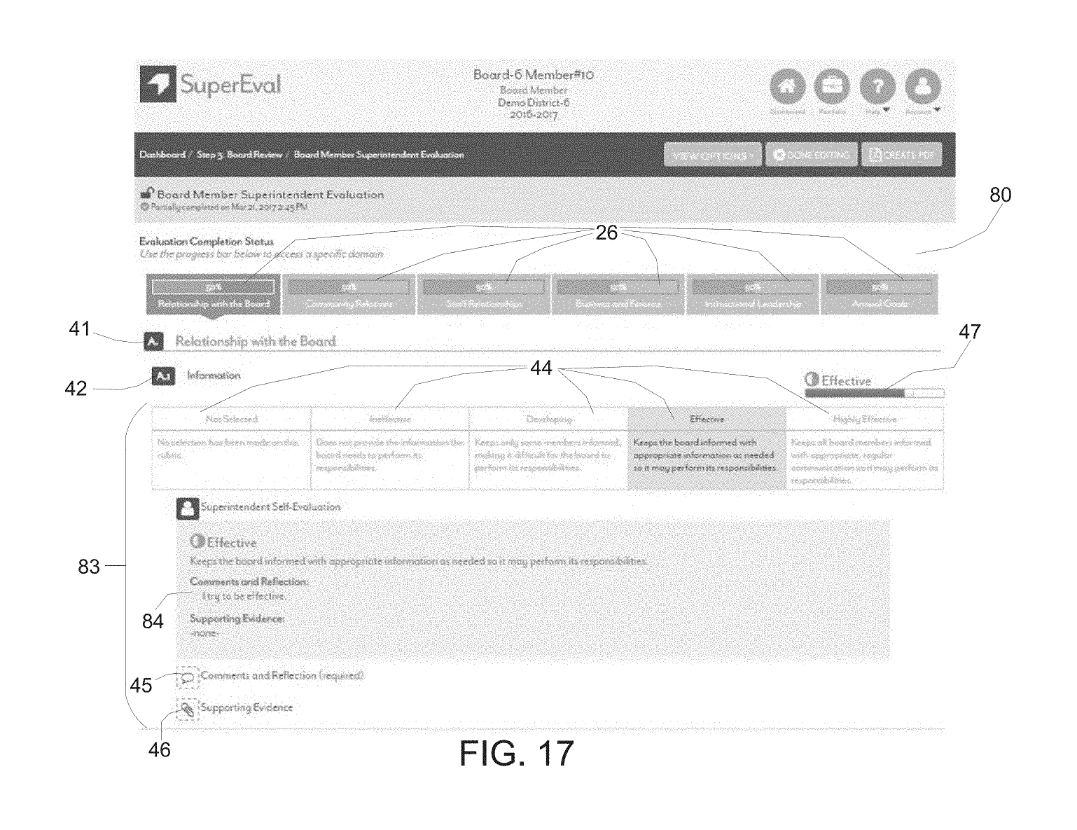

Creation of a prepopulated external-evaluation will now be described with reference to FIGS. 17-22. FIG. 17 shows an external-evaluation entry screen 80 that is substantially similar to self-evaluation entry screen 40 described above. External-evaluation entry screen 80 includes domain progress bars 26 for the various domains of the evaluation rubric. Entry screen 80 displays an external-evaluation entry prompt 83 that corresponds to specific competency 42 within a domain 41. External-evaluation entry prompt 83 includes predefined grades 44, Comments and Reflections icon 45, Supporting Evidence icon 46, and selected grade indicator 47.

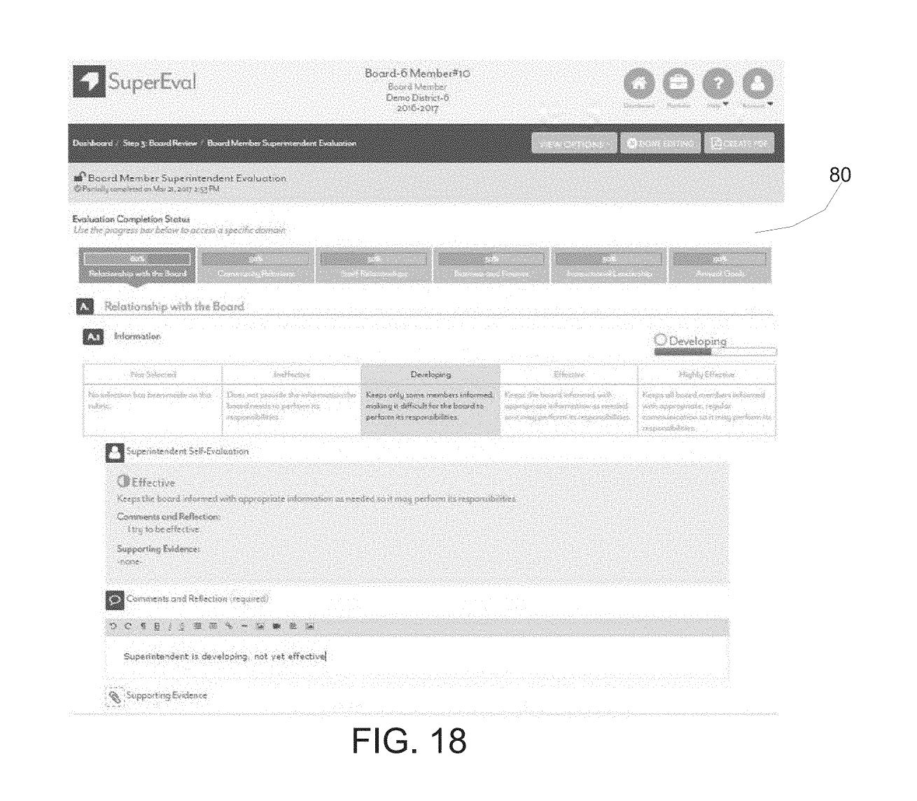

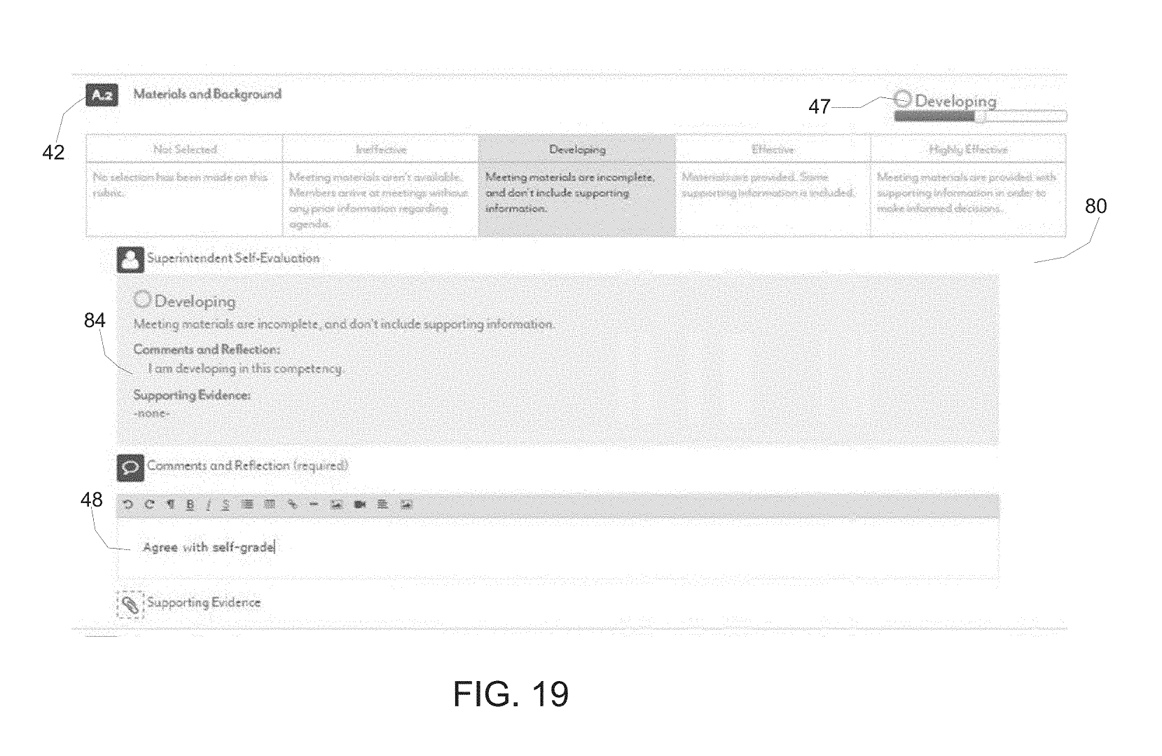

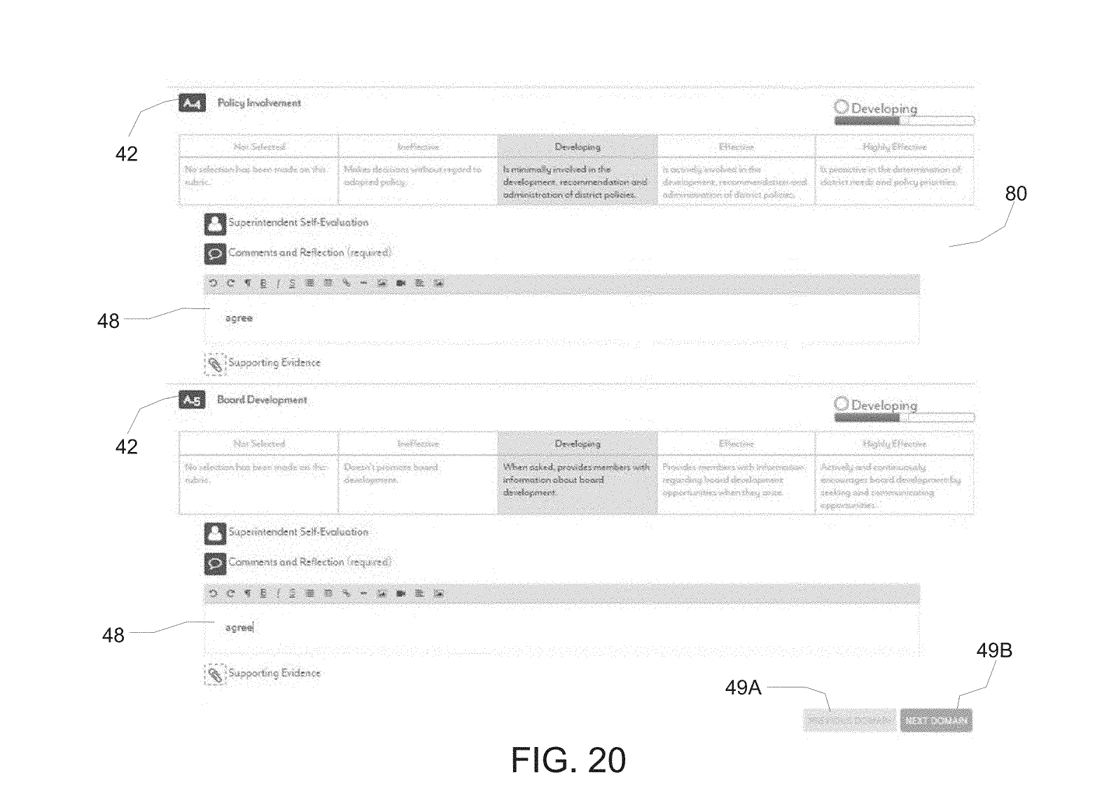

Because button 76 was selected to create the external evaluation, external-evaluation entry prompt 83 further includes a self-evaluation display box 84 displaying the self-grade, reflections, and supporting evidence uploaded by employee 6 for the particular competency 42. In addition, the selected grade indicator 47 is automatically set to the self-grade chosen by employee 6 during self-evaluation step two. The group member 4, 4L providing the external-evaluation may choose to keep the same grade chosen by the employee. In this way, the pre-population option can expedite the evaluation process. The group member 4, 4L is free to select another grade. FIG. 18 is a view similar to that of FIG. 17, showing entry of a grade and a comment by the group member 4, 4L, wherein the grade and comment differ from the corresponding prepopulated self-grade and self-reflection submitted by employee 6. FIG. 19 is a view of external-evaluation entry screen 80, showing entry of a grade and a comment by the group member, wherein the grade is the same as the corresponding prepopulated self-grade submitted by the employee. The comment is entered by clicking Comments and Reflections icon 45 to display text field 48 and entering text in the text field 48 as shown in FIG. 19. FIG. 20 shows entry of grades and comments by group member 4, 4L for further specific competencies 42 in competency domain 41 before proceeding to a next domain 41.

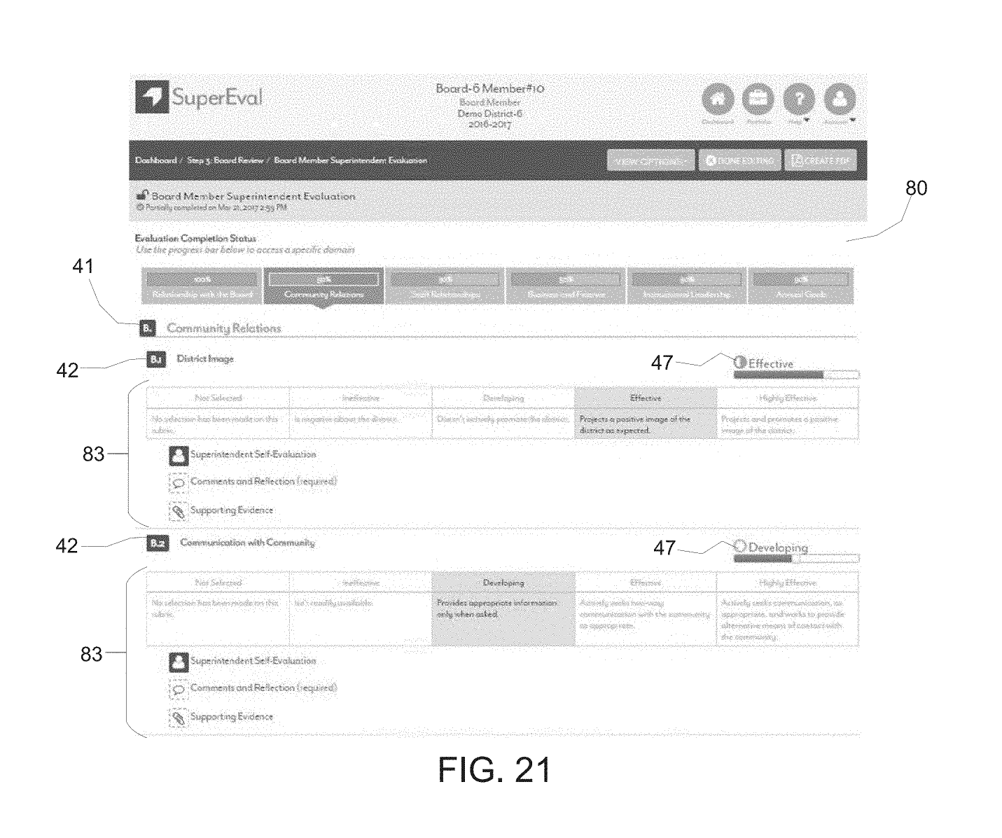

FIG. 21 shows external-evaluation entry prompts 83 in the next competency domain 41, which in the example rubric is designated “Community Relations.” Each prompt 83 is associated with a specific competency 42 within domain 41. In the example rubric, the specific competencies 42 include “District Image” and “Communication with Community.” As may be seen, the entry prompts 83 are prepopulated with corresponding self-evaluation information submitted by employee 6.

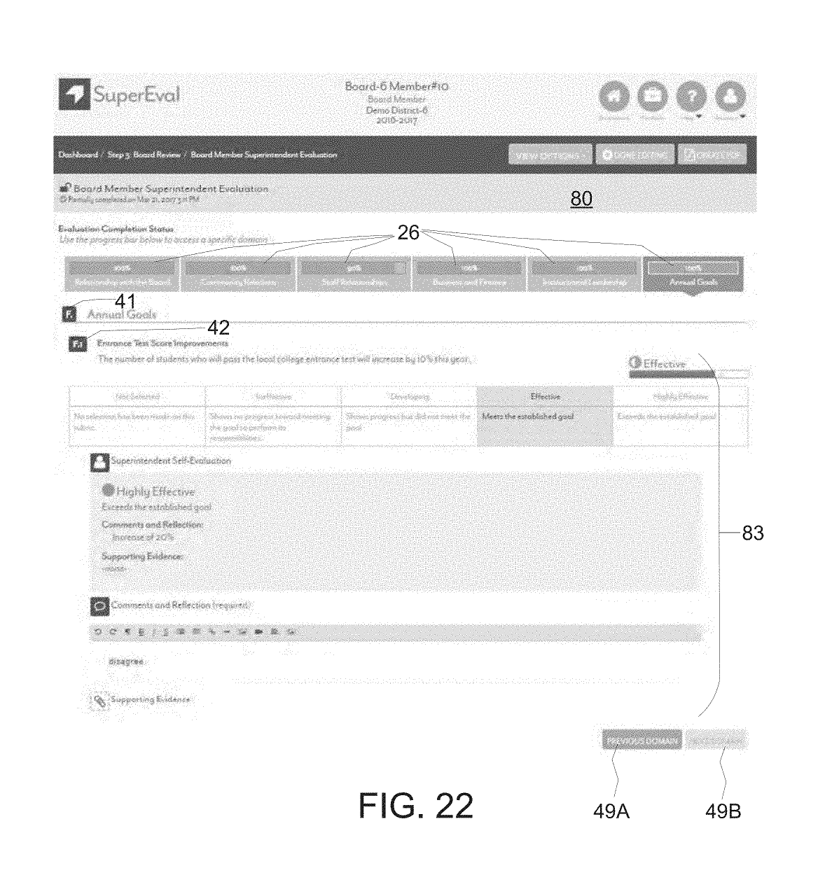

FIG. 22 shows completion of the entry of external-evaluation information by the group member 4, 4L. The final competency domain 41 comprises annual goal(s) submitted by employee 6. As may be seen, the group member disagrees with the employee's self-grade and has assigned a different grade for competency 42. As indicated by progress bars 26, entry of external-evaluation information is 100% complete for all domains except “Staff Relationships,” which is 90% complete. The group member may navigate through the various domains using PREVIOUS DOMAIN button 49A and NEXT DOMAIN button 49B and may edit information entered previously.

The entered external-evaluation information is uploaded and stored. The group member 4, 4L may return to secondary screen 60 and click the corresponding evaluation completion indicator 72 to indicate whether or not the group member has completed his or her external-evaluation. For example, evaluation completion indicator 72 may toggle from a red box with an X to a green box with a check mark to indicate completion. In addition to entering and editing his or her external-evaluation information, the logged-in group member may view the self-evaluation information submitted by employee 6 by clicking the evaluation access button 70 in the row 61 corresponding to the employee.

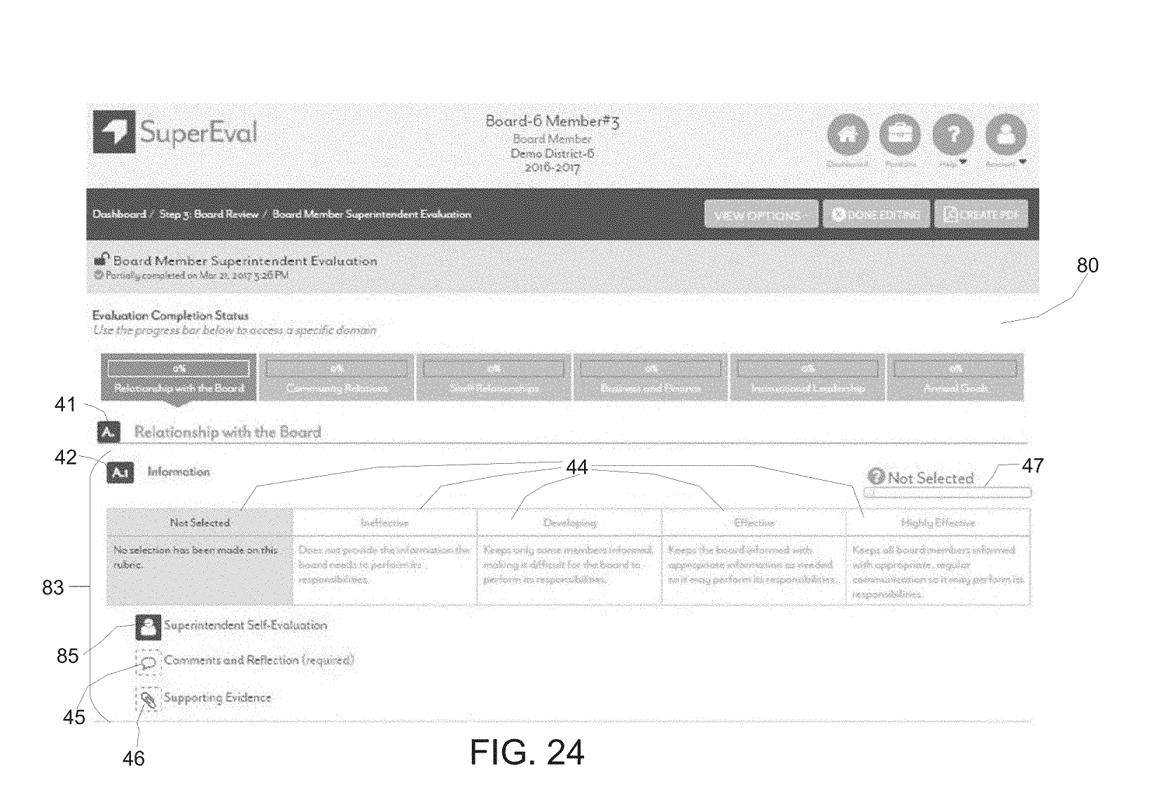

FIG. 24 is a view of external-evaluation entry screen 80 similar to that of FIG. 17, but illustrates a case where the group member 4, 4L has chosen to create an external-evaluation from scratch by selecting button 77 at pop-up prompt 75 described above. The process for entering external-evaluation information is the same as that followed when prepopulation button 76 is selected, except external-evaluation entry prompt 83 does not automatically display self-evaluation information entered by employee 6. The group member may nevertheless view corresponding self-evaluation by clicking self-evaluation icon 85. Entry prompt 83 includes the plurality of predefined grades 44, Comments and Reflections icon 45, Supporting Evidence icon 46, and selected grade indicator 47. The designation “Not Selected” may be the default grade 44 as shown in FIG. 24. The group member 4, 4L may select one of the grades 44 for competency 42 and the selected grade is reflected by grade indicator 47. In addition to selecting a grade for each competency 42, the group member 4, 4L is required to enter comments by way of Comments and Reflections icon 45 and the associated text field 48 (see FIG. 19). The group member may log in from time to time and navigate through the various domains 41 and competencies 42 to complete the external-evaluation.

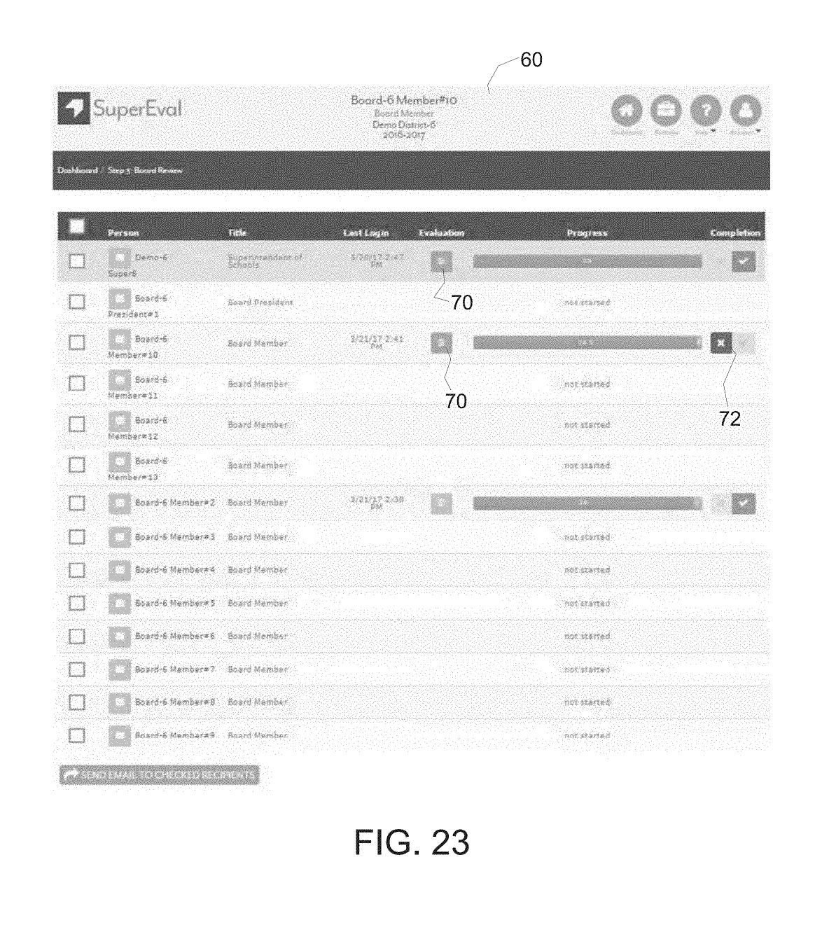

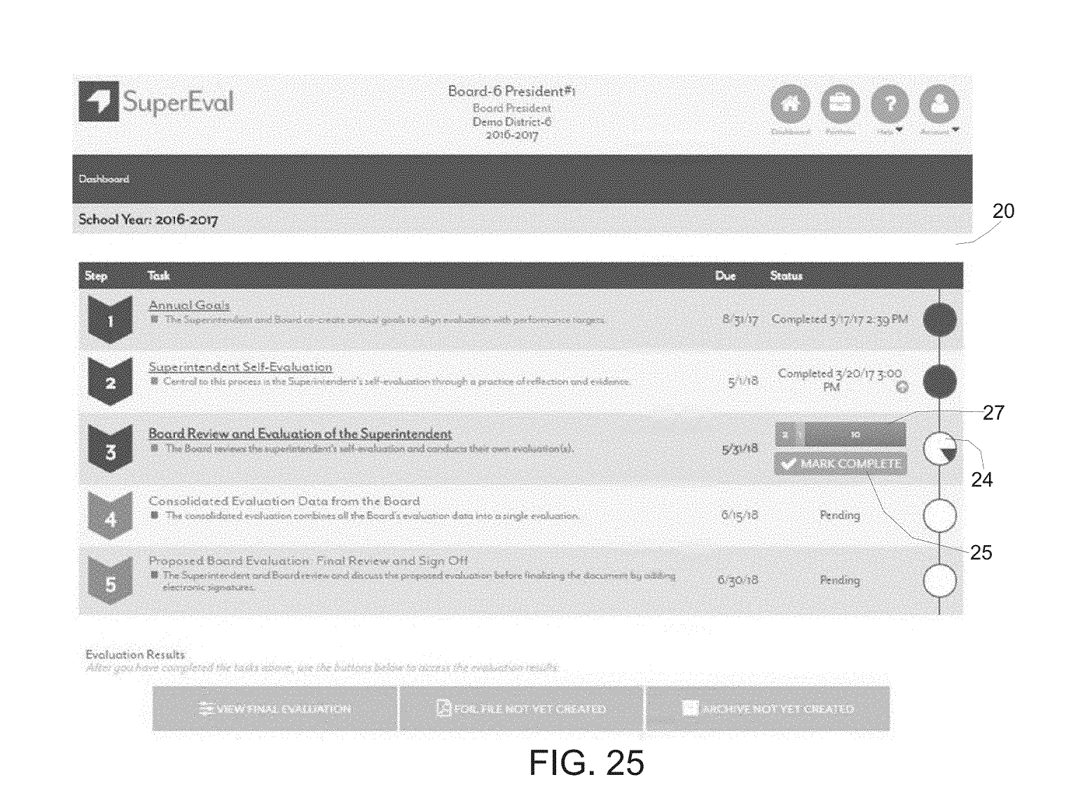

FIG. 25 shows main dashboard screen 20 during review and external evaluation of employee 6 by group members 4, 4L (step three). In the view of FIG. 25, the overall completion status of step three corresponds to the completion status indicated in greater detail by secondary screen 60 in FIG. 23. Main dashboard screen 20 displays a collective progress report indicating a proportion of group members 4, 4L who have completed transmitting external-evaluation information to the hub server 16, a proportion of group members who have started but not completed transmitting external-evaluation information to the hub server, and a proportion of group members who have not started transmitting external-evaluation information to the hub server. In the embodiment described herein, the collective progress report includes a bar graph 27 and pie graph 24. The group leader 4L is logged in, and therefore step completion button 25 is displayed to allow the group leader to mark step three completed.

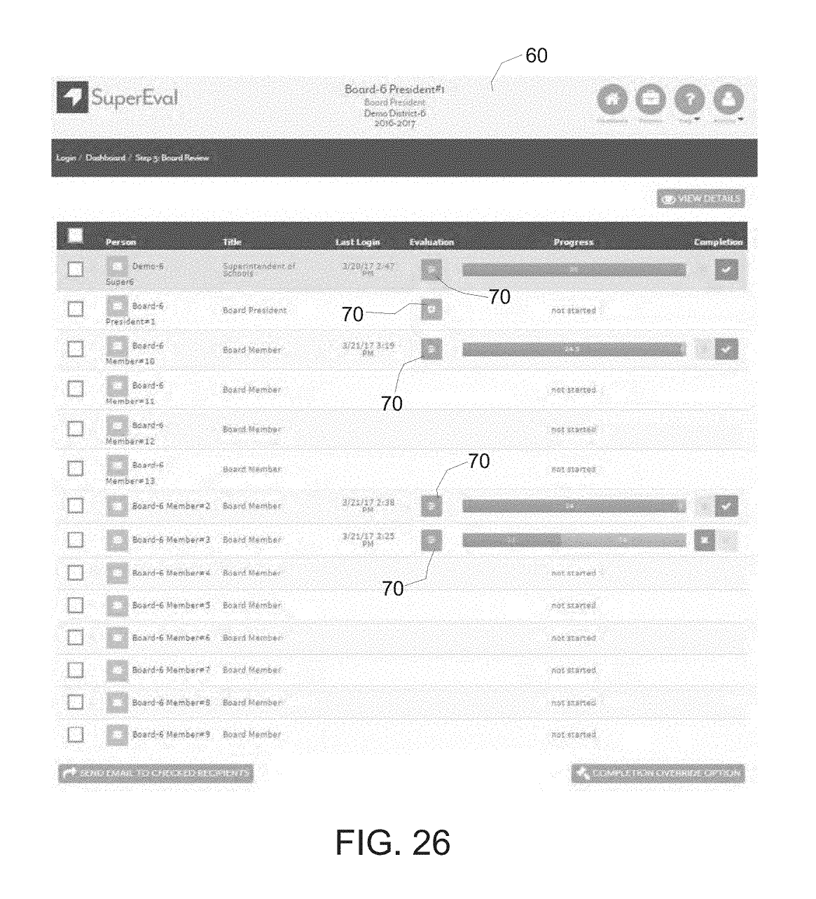

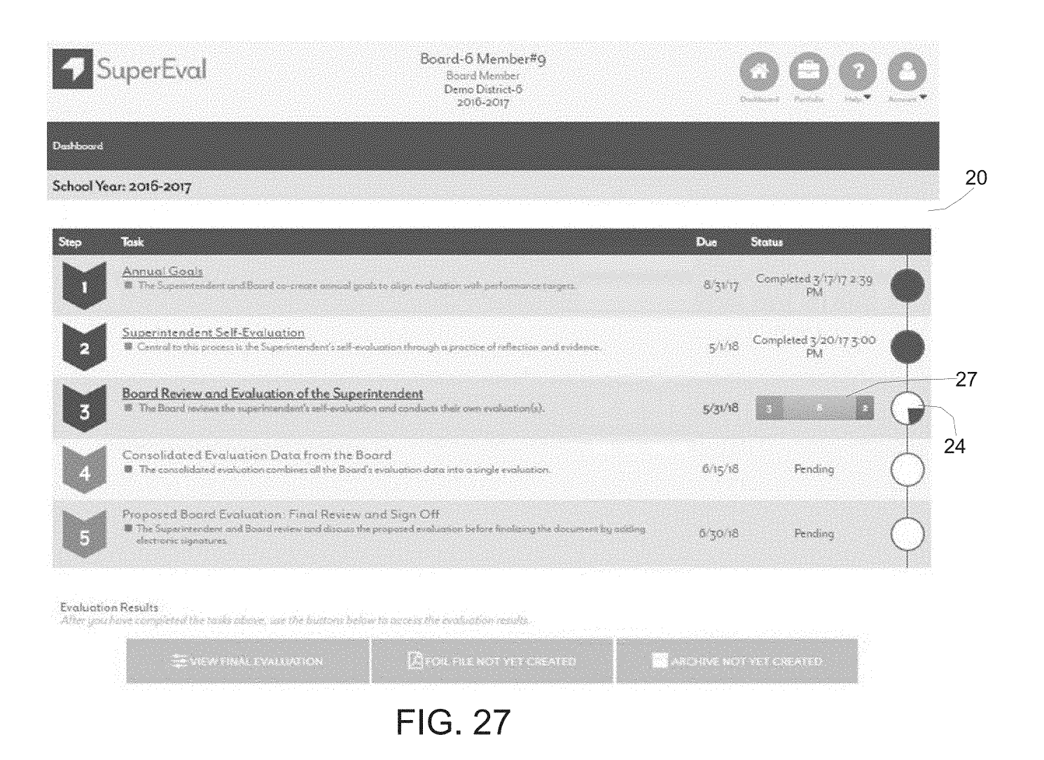

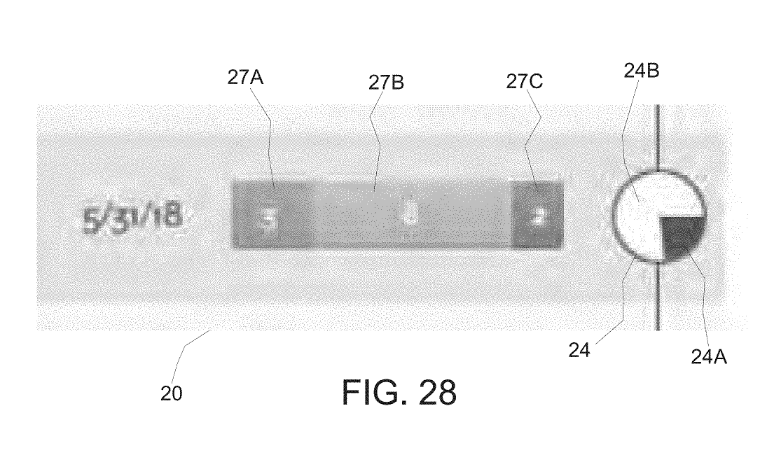

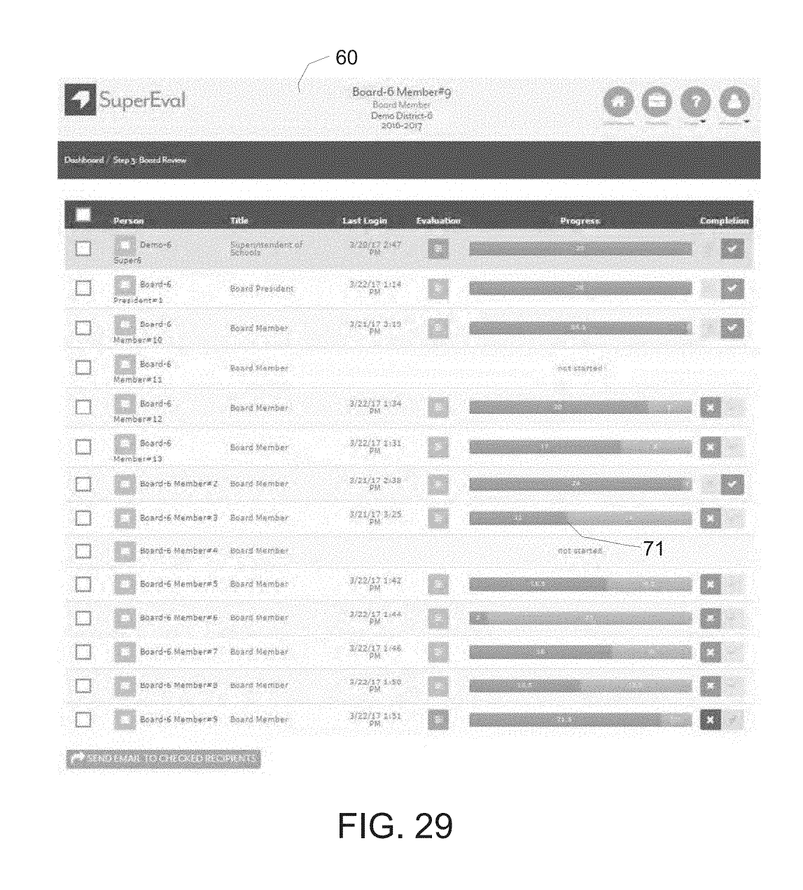

FIG. 26 is a view of secondary screen 60 similar to that of FIG. 23, but the group leader 4L is logged in and using the evaluation dashboard application. The group leader 4L has access to the details of each evaluation by clicking the corresponding evaluation access button 70 for each participant 8. Evaluation access button 70 in the group leader's own row allows the group leader (e.g. Board President) to create and evaluation if an evaluation has not yet been created by the group leader. In the view of FIG. 26, the employee has completed the self-evaluation, two group members 4 have completed external-evaluations, another group member 4 has partially completed the external-evaluation process, and the remaining group members 4 and group leader 4L have not yet started the external-evaluation process. FIG. 27 shows main dashboard screen 20 as review and external-evaluation of the employee by group members progresses further, with more group members 4 starting their external-evaluations. FIG. 28 is a close-up view of a completion status graphic displayed on the main dashboard screen shown in FIG. 27. The completion status graphic includes pie graph 24 and bar graph 27. Pie graph 24 shows the proportion of group members 4, 4L who have completed their respective external-evaluation. Pie graph 24 has a shaded region 24A indicating completed external-evaluations, which in the current example is three out of thirteen total group members 4, 4L, and an unshaded region 24B representing external-evaluations that have not yet been completed (ten out of thirteen). Bar graph 27 provides a segmented breakdown with a first segment 27A showing the number of external-evaluations completed (three), a second segment 27B showing the number of external-evaluations started but not yet completed (eight), and a third segment 27C showing the number of external-evaluations not yet started (two). FIG. 29 is a view of secondary screen 60 providing a detailed breakdown of the overall completion status indicated more generally by the completion status graphic displayed on the main dashboard screen 20 as shown in FIG. 28. Secondary screen 60 identifies which group members 4, 4L have completed their external evaluation, which group members have started but not yet completed their external-evaluation, and which group members have not yet started their external-evaluation. The progress of each group member who has started their external-evaluation is indicated by the respective evaluation progress bar graph 71. Each evaluation progress bar graph 71 indicates how many competencies 42 have been completed in the evaluation process and how many competencies 42 remain to be completed. For example, in FIG. 29, Member #3 has completed eleven competencies and has fourteen more competencies to complete in the evaluation.

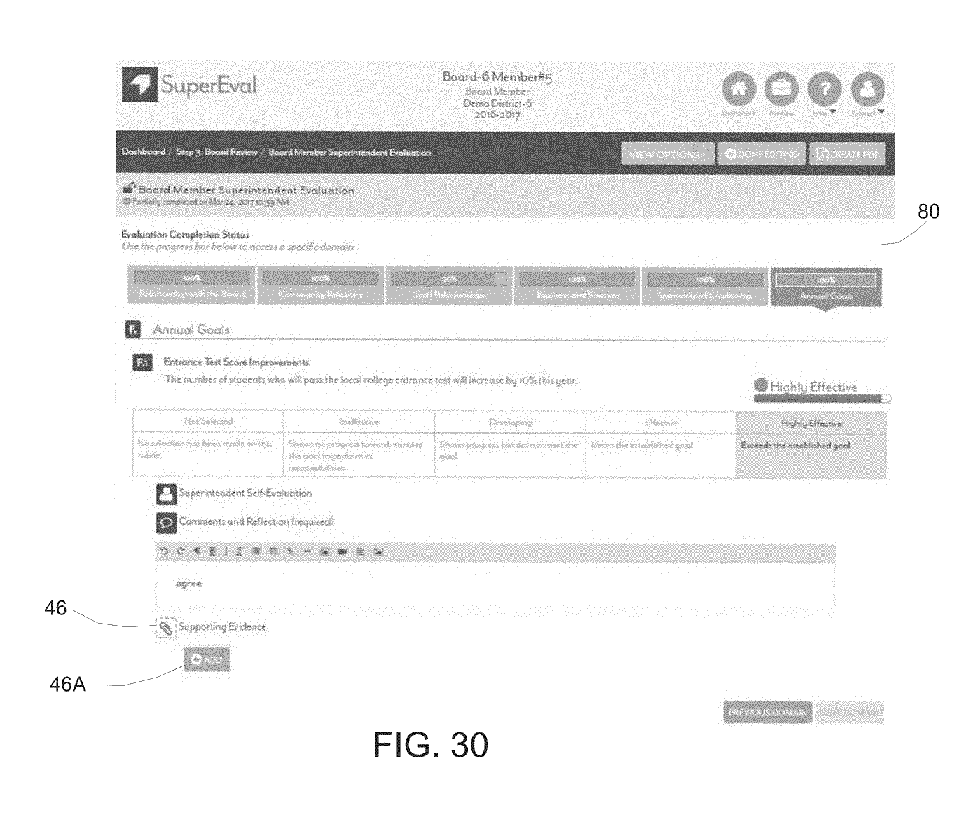

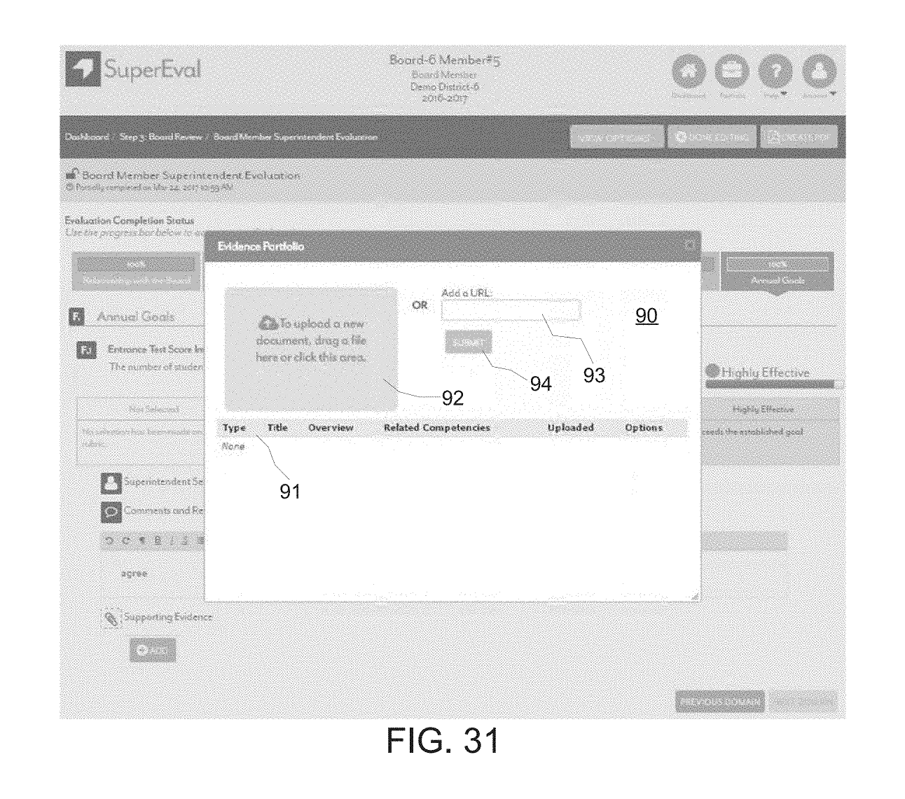

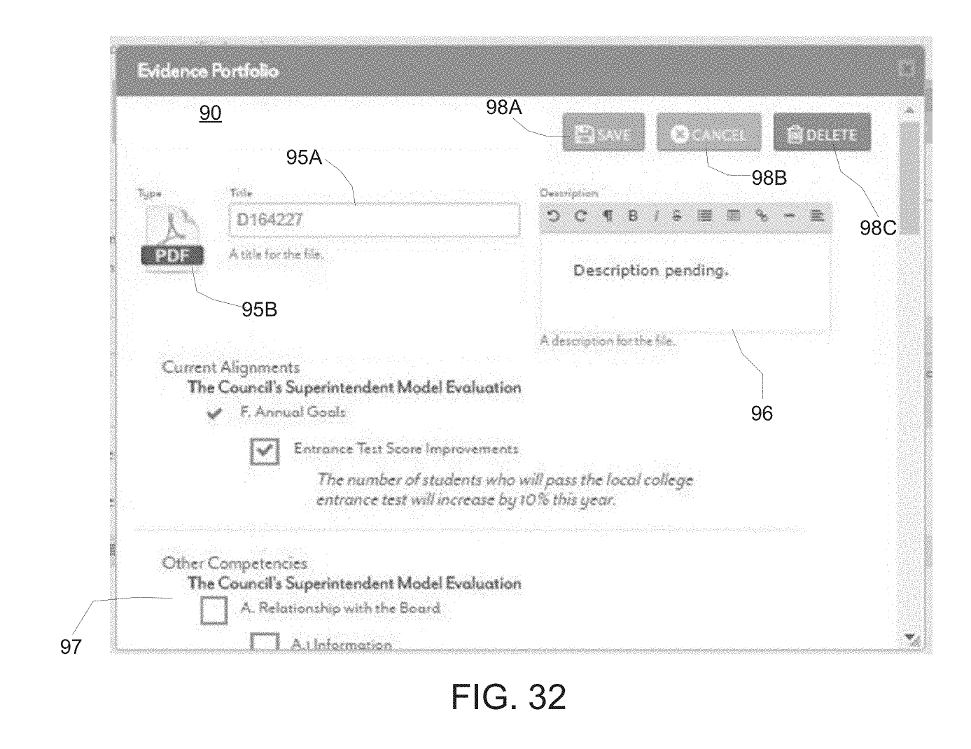

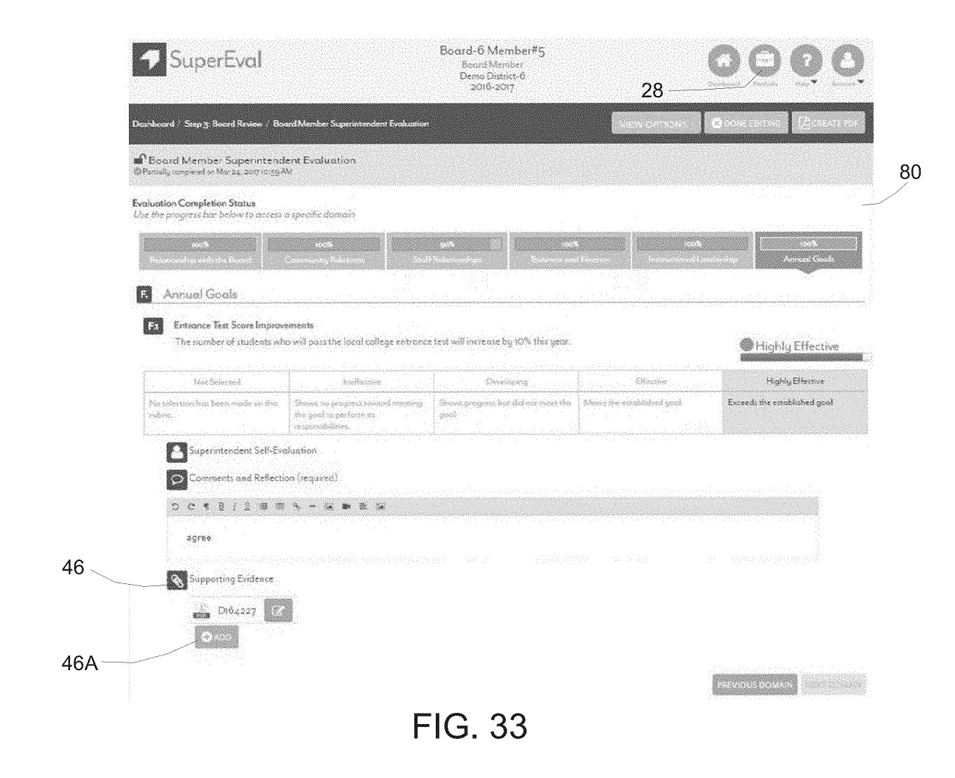

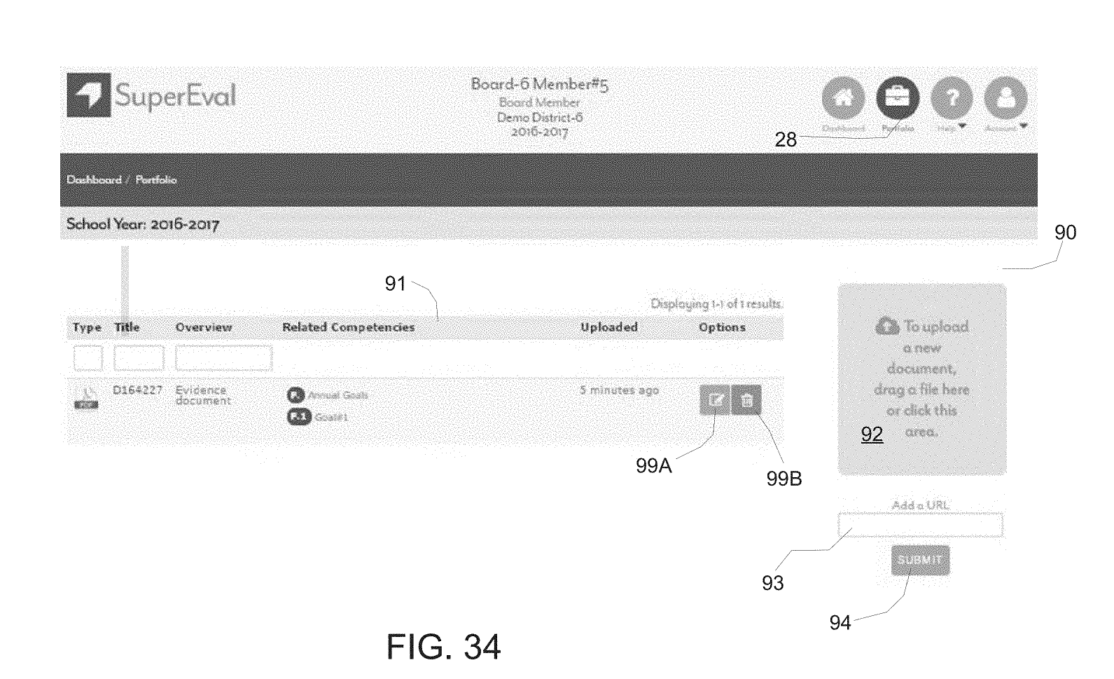

FIGS. 30-34 illustrate the use of Supporting Evidence icon 46 to upload documents as evidence for supporting a self-evaluation by the employee 6 or an external evaluation by a group member 4, 4L. While the use of Supporting Evidence icon 46 is described in relation to an external-evaluation carried out through external-evaluation entry screen 80, it is understood that a similar process may be followed when Supporting Evidence icon 46 is used from self-evaluation entry screen 40. As shown in FIG. 30, when Supporting Evidence icon 46 is clicked an ADD button 46A is displayed. The user may click ADD button 46A, thereby displaying an evidence attachment screen 90 as shown in FIG. 31. Evidence attachment screen 90 includes an evidence list 91 providing information about each uploaded evidentiary document, a drag-and-drop box 92 onto which the user may drag and drop a file from the remote computer's local directory for upload, an address box 93 for entry of a URL address of a webpage to be used as evidence, and a SUBMIT button 94 for submitting the file or URL address. FIG. 32 shows evidence attachment screen 90 after a file is selected for attachment as supporting evidence in connection with one of the specific competencies (e.g. competency “Entrance Test Score Improvements” in the “Annual Goals” domain). Displayed on evidence attachment screen 90 are text box 95A indicating a title for the selected file, which may be the original file name by default, and a file type icon 95B indicating the file type, for example an Adobe PDF document. A text box 96 is also provided to allow the user to enter a brief textual description of the evidence. By default, the evidence is associated with the relevant competency from external-evaluation entry screen 80 (FIG. 30), however a check box portion 97 may be provided as part of evidence attachment screen 90 to allow the user to selectively associate the same evidence to other chosen competencies in the evaluation rubric. A SAVE button 98A, CANCEL button 98B, and DELETE button 98C are provided for uploading and saving the evidence, canceling the evidence addition task, or deleting a previously saved evidentiary document, respectively. If the user clicks SAVE button 98A, the uploaded evidentiary document will be listed under Supporting Evidence icon 46 on external-evaluation entry screen 80 as shown in FIG. 33. FIG. 34 shows another iteration of evidence attachment screen 90 accessed by clicking a portfolio icon 28 located next to home icon 21. An edit button 99A and a delete button 99B are provided for each listed document.

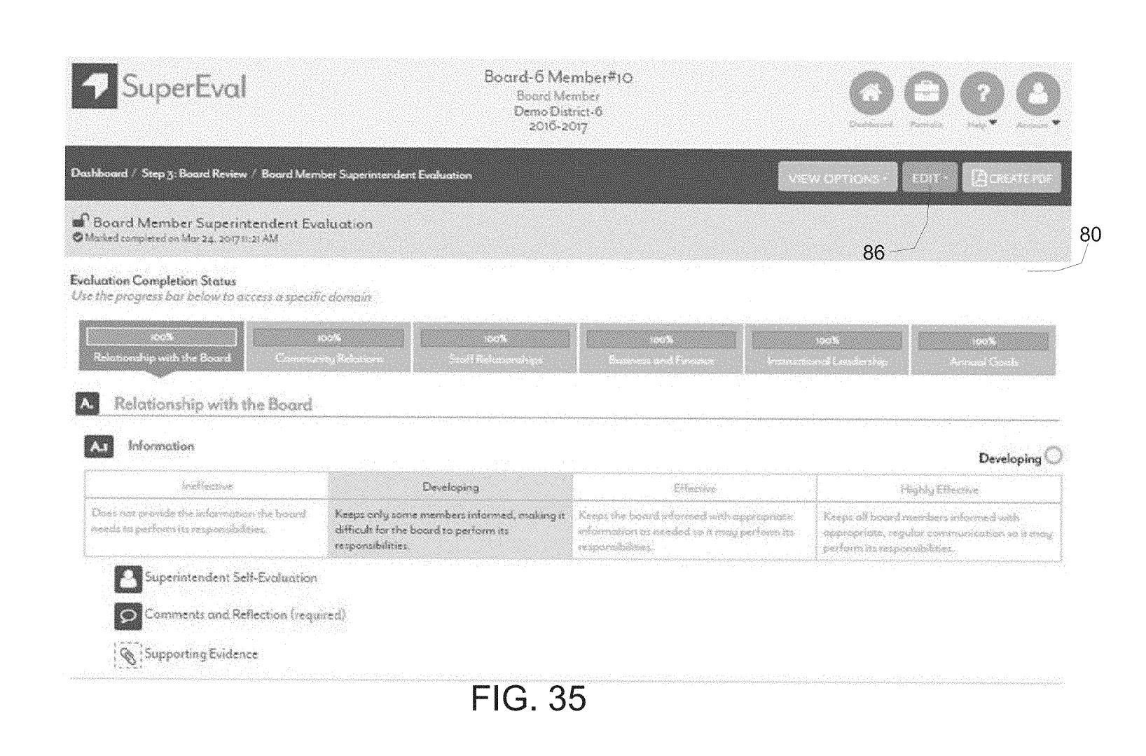

FIG. 35 is a view of external-evaluation entry screen 80 similar to those of FIGS. 17 and 24, illustrating an EDIT button 86 selectable by a group member to allow uploaded external-evaluation information to be edited instead of merely viewed.

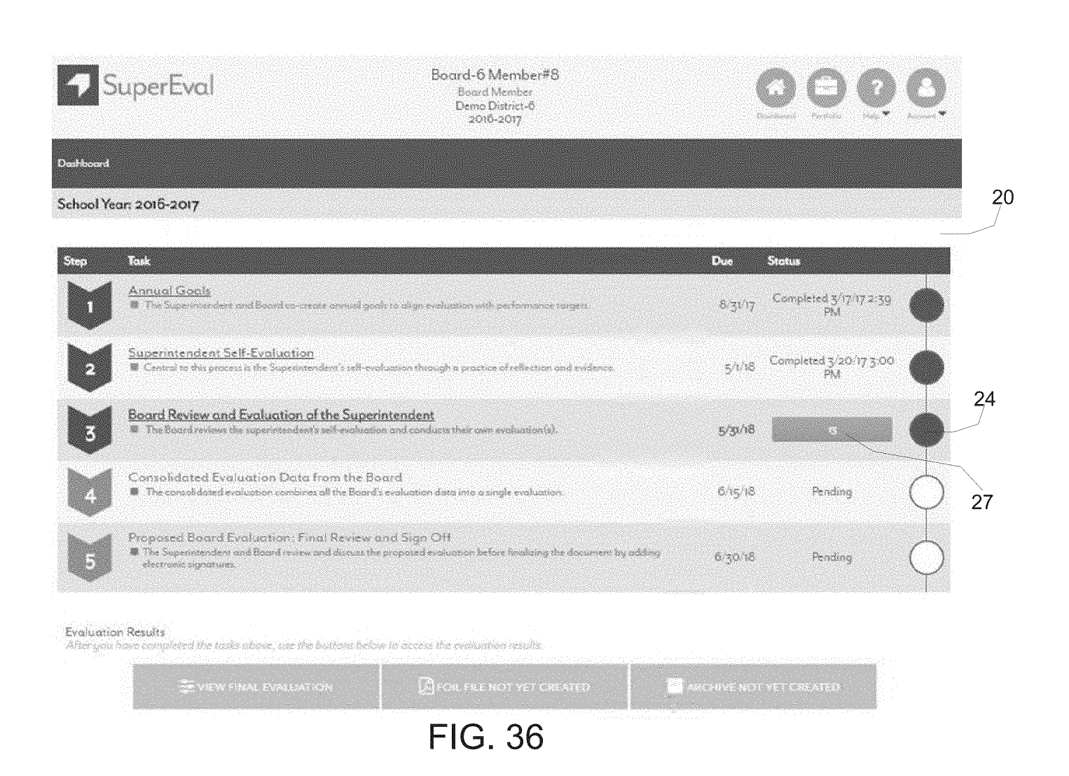

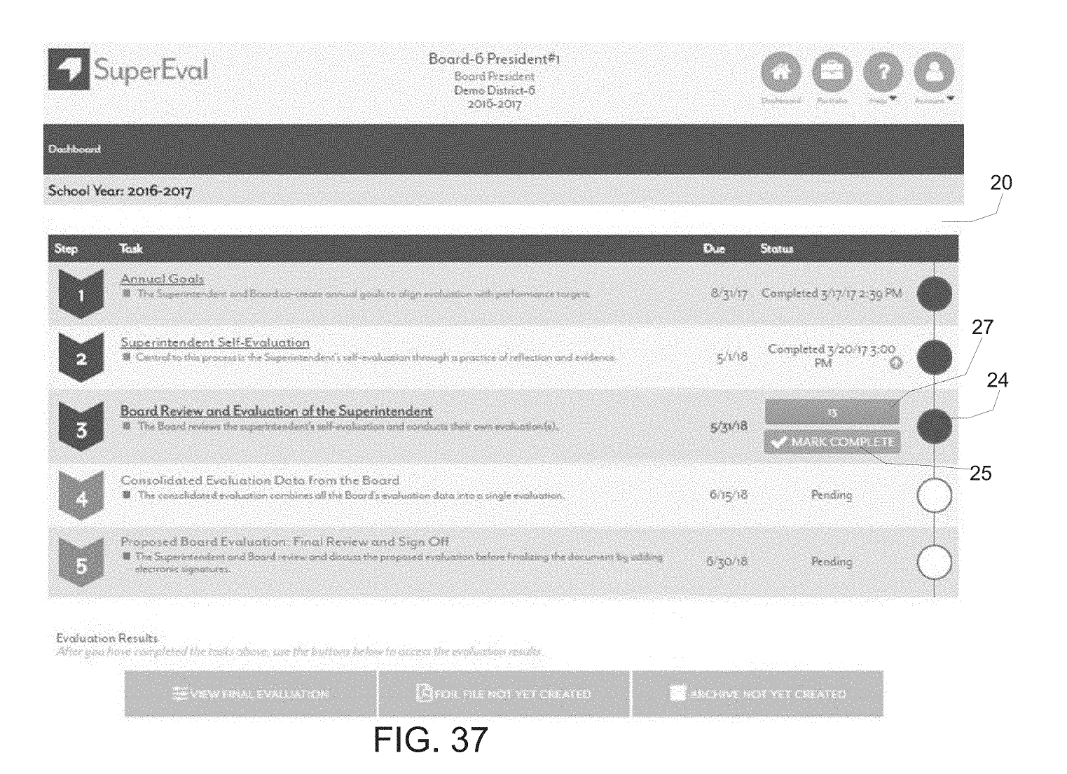

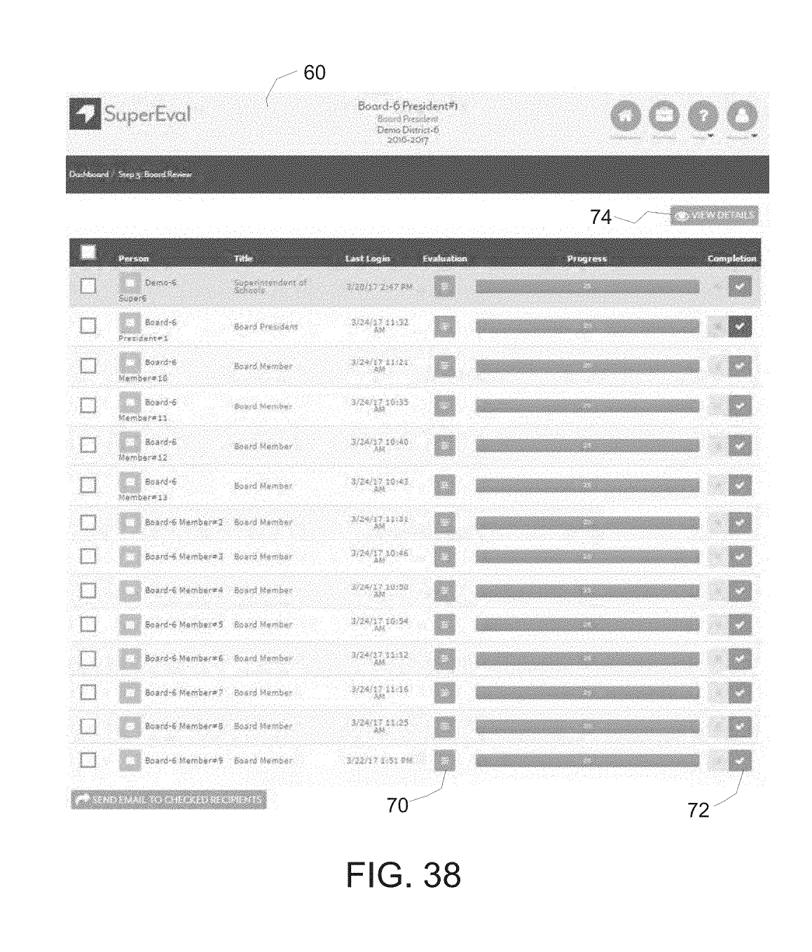

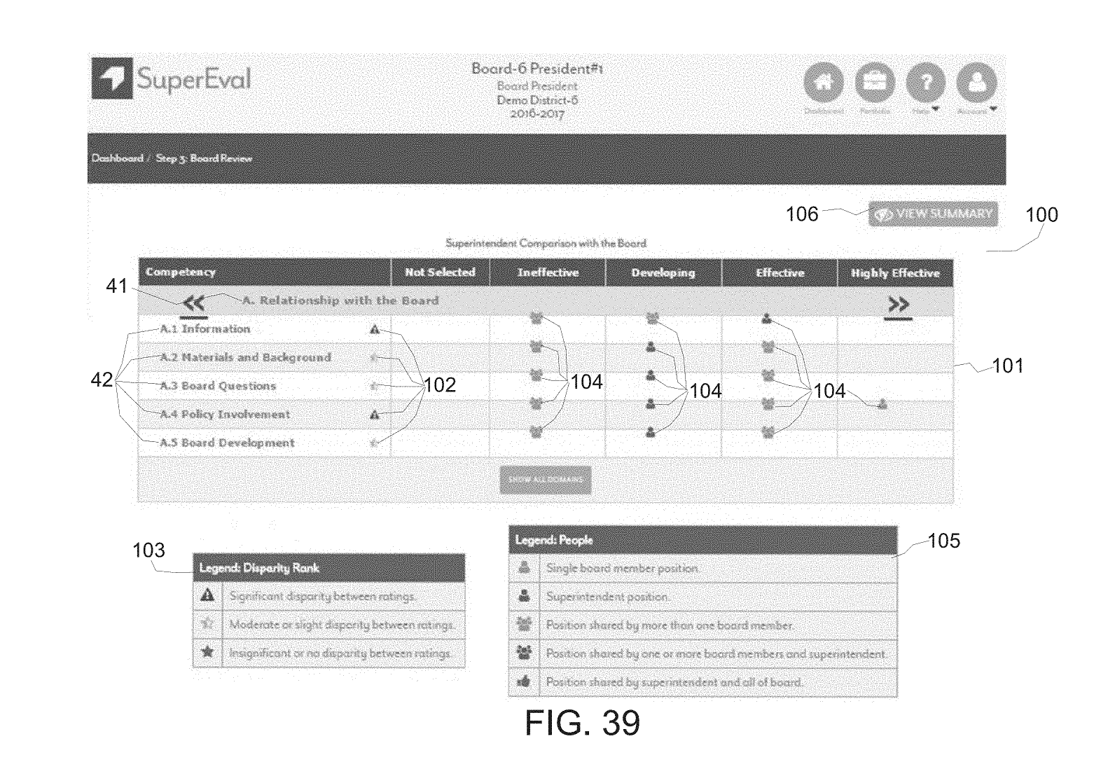

FIG. 36 shows the main dashboard screen 20 of the evaluation dashboard application after all group members 4, 4L have completed entering external-evaluation information In the present example, bar graph 27 indicates all thirteen group members have completed respective external-evaluations, and pie graph 24 is completely shaded. In FIG. 36, the logged-in group member is not the group leader 4L, and does not have authority to mark step three as being completed. By contrast, FIG. 37 shows main dashboard screen 20 when the group leader 4L (the Board President) is logged in. As may be seen, step completion button 25 is displayed so that the group lead 4L may click on the step completion button to mark step three completed. FIG. 38 shows secondary screen 60 of the evaluation dashboard application when the group leader is logged in but has not yet marked the external-valuation step completed. Each group member 4, 4L has toggled his or her respective evaluation completion indicator 72 to indicate that the corresponding external-evaluation is complete. The group leader 4L has authority to view the evaluation information submitted by the employee and each group member by clicking the corresponding evaluation access button 70, all of which are active for the group leader 4L. The group leader 4L may also view a consolidated presentation of all the submitted evaluation information by clicking a VIEW DETAILS button 74 on secondary screen 60. For example, FIG. 39 shows a consolidated comparison screen 100 available to group leader 4L by clicking VIEW DETAILS button 74. Consolidated comparison screen 100 may display a table 101 indicating how assigned grades are spread among the group members 4, 4L and the employee 6 for each of the competencies 42 in each domain 41. A disparity rank symbol 102 indicating a degree of disparity among the assigned grades may be provided for each competency 42, and a people symbol 104 may be provided for each of the predefined grades 44 depending upon which and/or how many participants assigned a particular grade. Legend 103 explains the various disparity rank symbols 102, and legend 105 explains the various people symbols 104. The logged-in group leader 4L may return to secondary screen 60 by clicking a VIEW SUMMARY button 106.

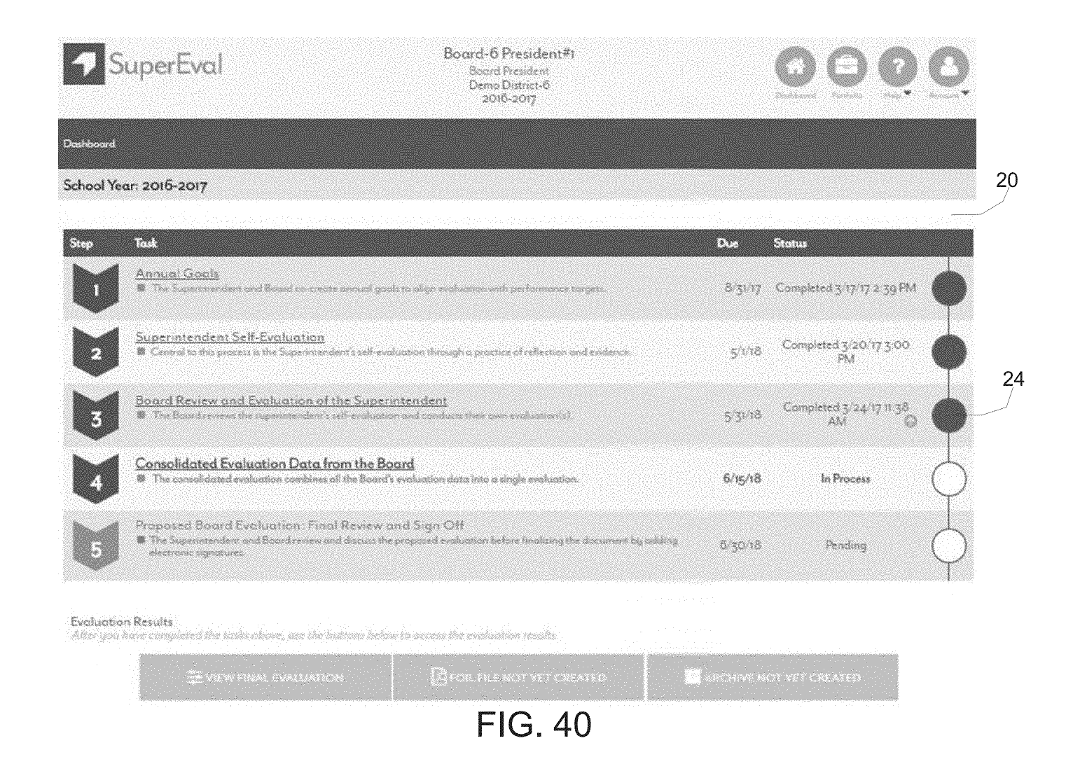

If the group leader 4L is satisfied that all necessary external-evaluation information has been submitted, he or she may return to main dashboard screen 20 to mark the external-evaluation step (step three) completed. FIG. 40 shows main dashboard screen 20 after group leader 4L has marked step three completed by clicking step completion button 25, which is visible in FIG. 37. Once step three is marked completed, the group members 4, 4L can no longer edit the stored external-evaluation information entered during step three. As may be seen in FIG. 40, flow proceeds to step four.

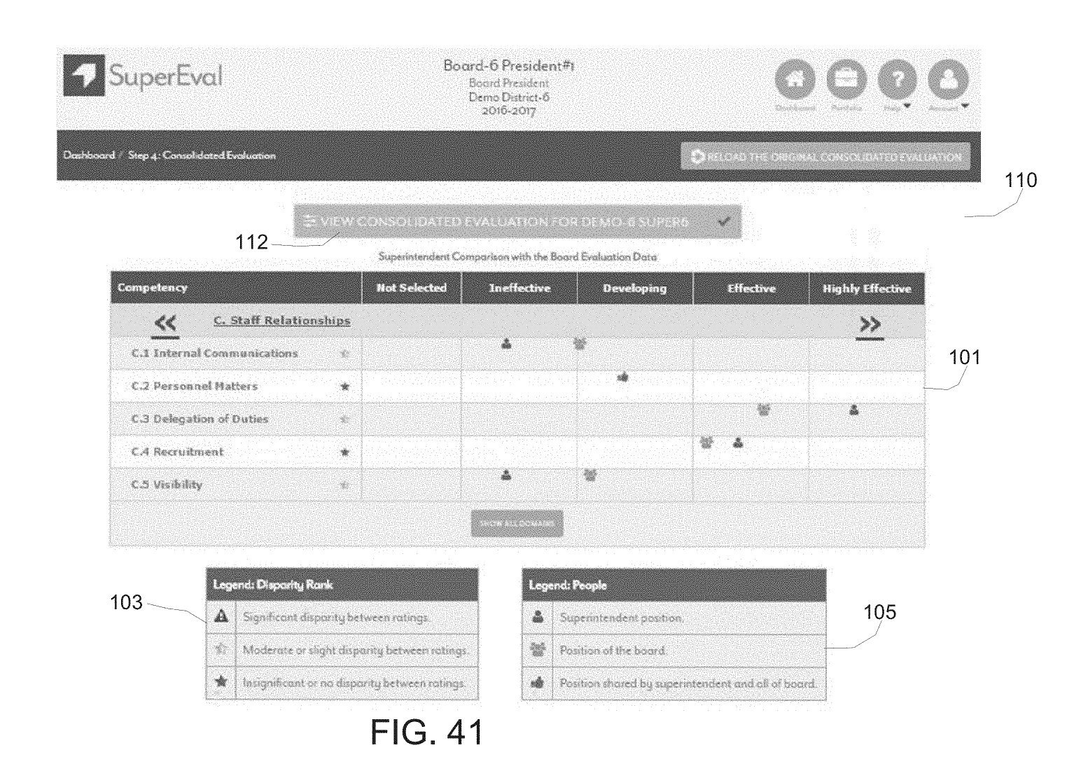

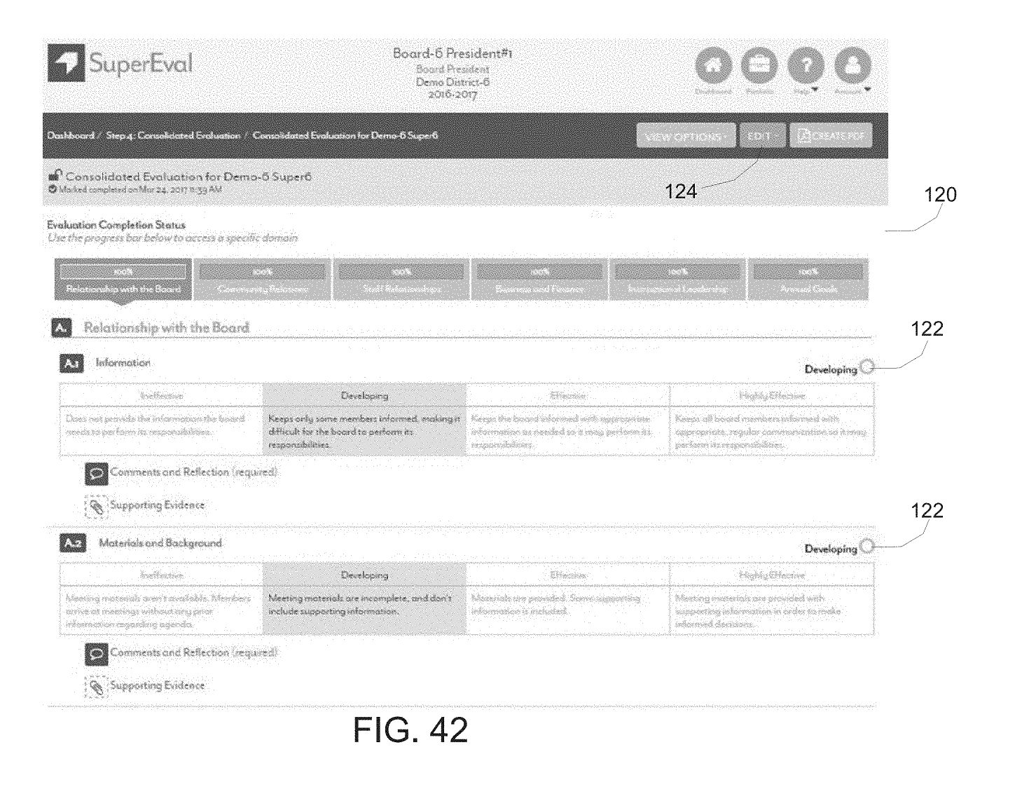

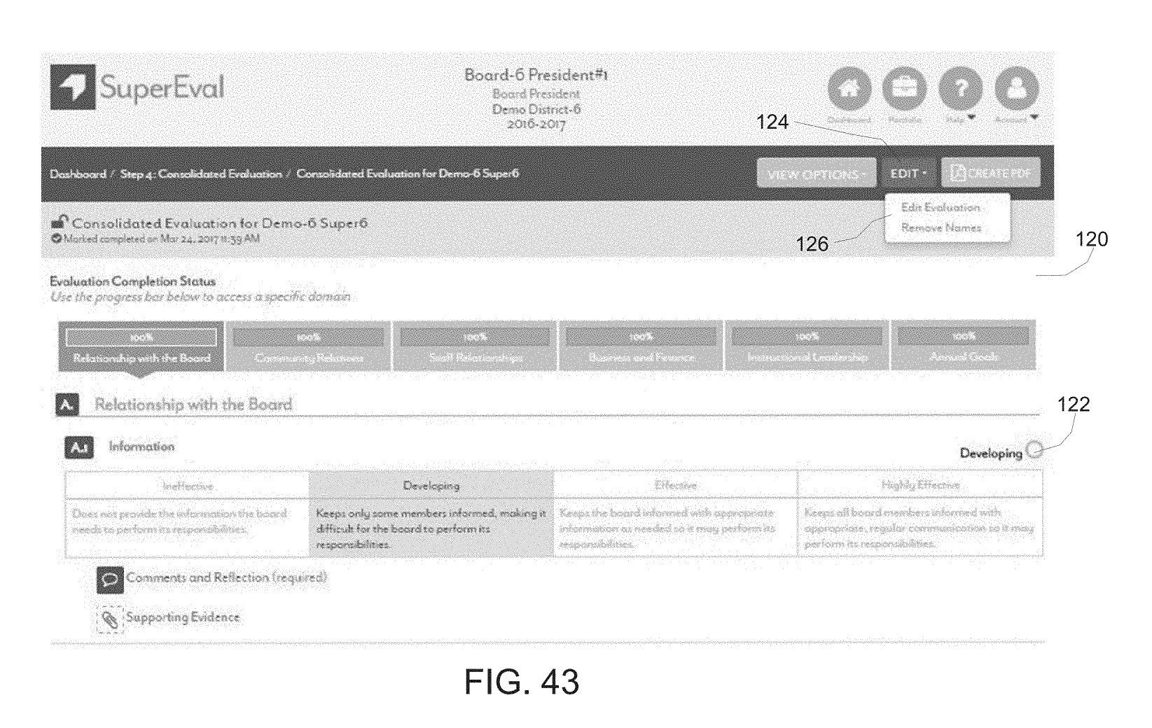

Step four of the evaluation process involves the creation of a single consolidated evaluation taking into account all the external evaluation information submitted by the group members 4, 4L. FIG. 41 shows a consolidated comparison screen 110 available to group leader 4L following completion of the external-evaluation step (step three). As may be seen, consolidated comparison screen 110 is similar to consolidated comparison screen 100 shown in FIG. 39, however the available a VIEW CONSOLIDATED EVALUATION button 112 is provided which the group leader may click to display a consolidated evaluation screen 120, shown in FIG. 42, presenting a single proposed external-evaluation grade 122 for each competency 42 based upon the grades submitted by the various group members 4, 4L. The consolidated evaluation further includes all the comments and evidence submitted by the group members 4, 4L, but not the comments and evidence submitted by employee 6. An EDIT button 124 is provided so that group leader 4L may edit information in the consolidated evaluation such as grades 122. Upon clicking EDIT button 124 as shown in FIG. 43, group leader 4L is prompted at box 126 to edit evaluation information or remove names of reviewers so that evaluation information is anonymous.

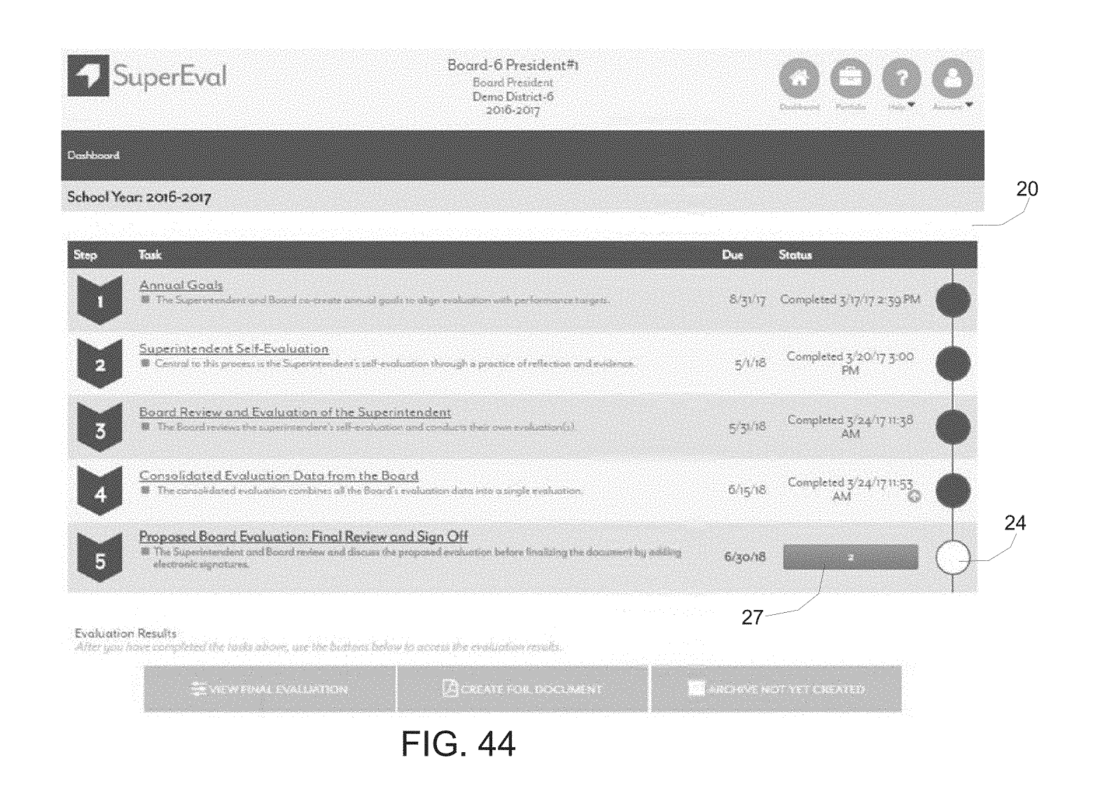

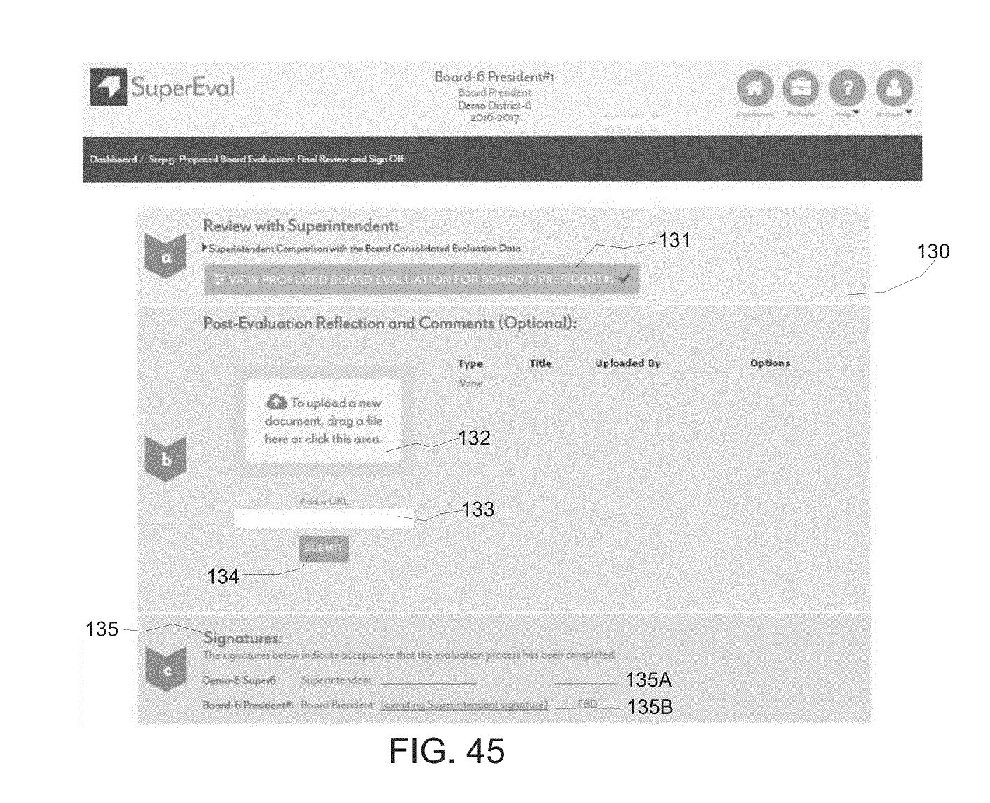

FIG. 44 shows main dashboard screen 20 of the evaluation dashboard application after group leader 4L has finalized the consolidated evaluation by marking step four completed. As may be seen, flow proceeds to step five. In step five, the employee 6 and the group members 4, 4L review and discuss the consolidated evaluation created in step four and finalize the evaluation by signing it. The evaluation dashboard application allows the evaluation to be signed by electronic signature. In the example embodiment described herein, two signatures are required, that of the employee 6 and that of the group leader 4L. Therefore, at the outset of step five, completion bar graph 27 for step five indicates two signatures are required, and pie graph 24 for step five is unshaded. In the view of FIG. 44, the group leader 4L is logged in and may click on step five to display an evaluation review screen 130 as shown in FIG. 45. Evaluation review screen 130 allows group leader 4L and employee 6 to review the proposed evaluation (sub-step a), add post-evaluation reflections and comments to the record (sub-step b), and sign off on the employee evaluation (sub-step c).

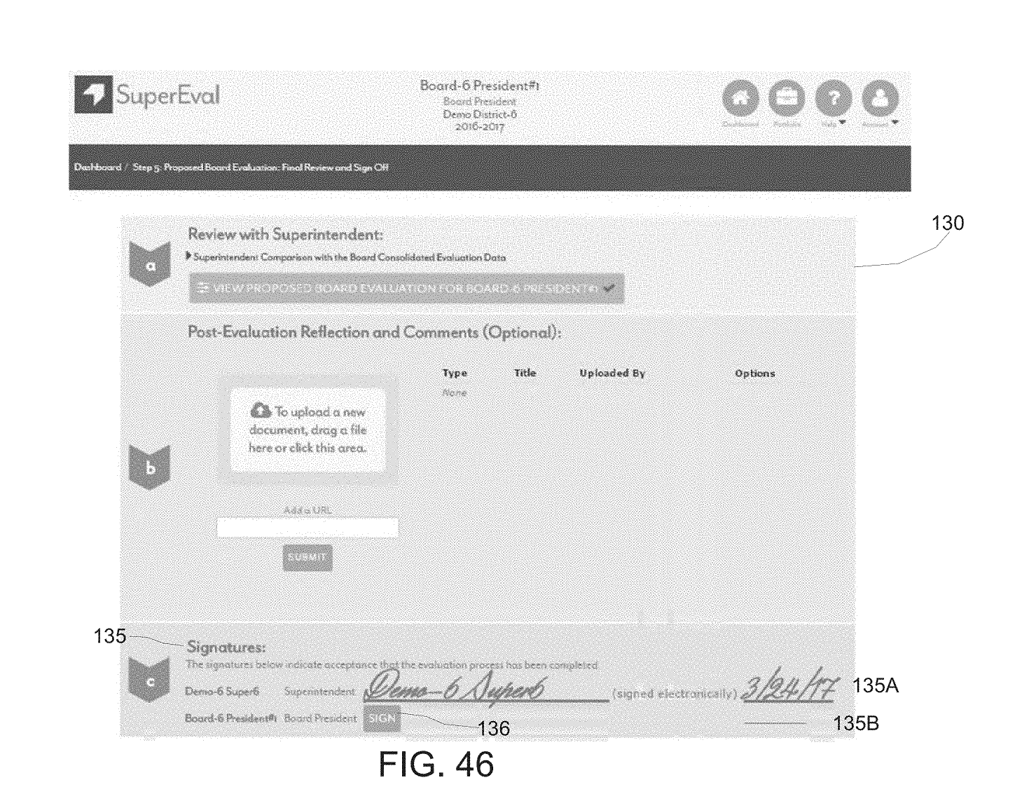

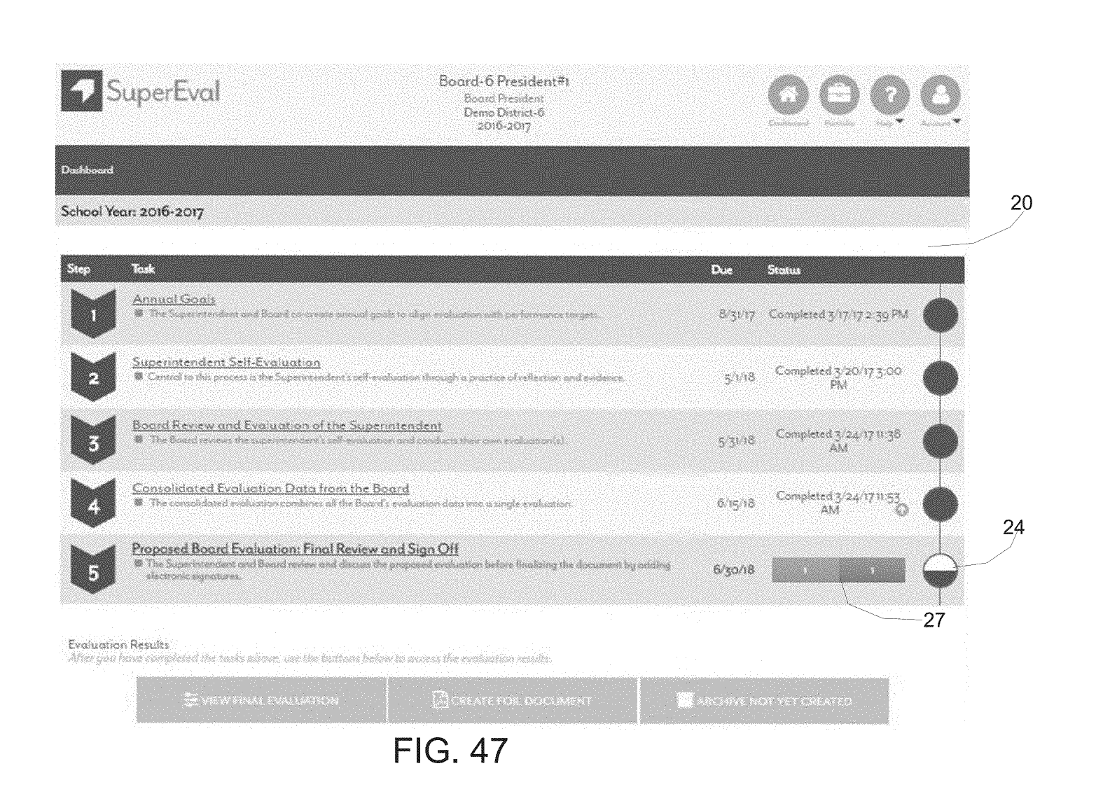

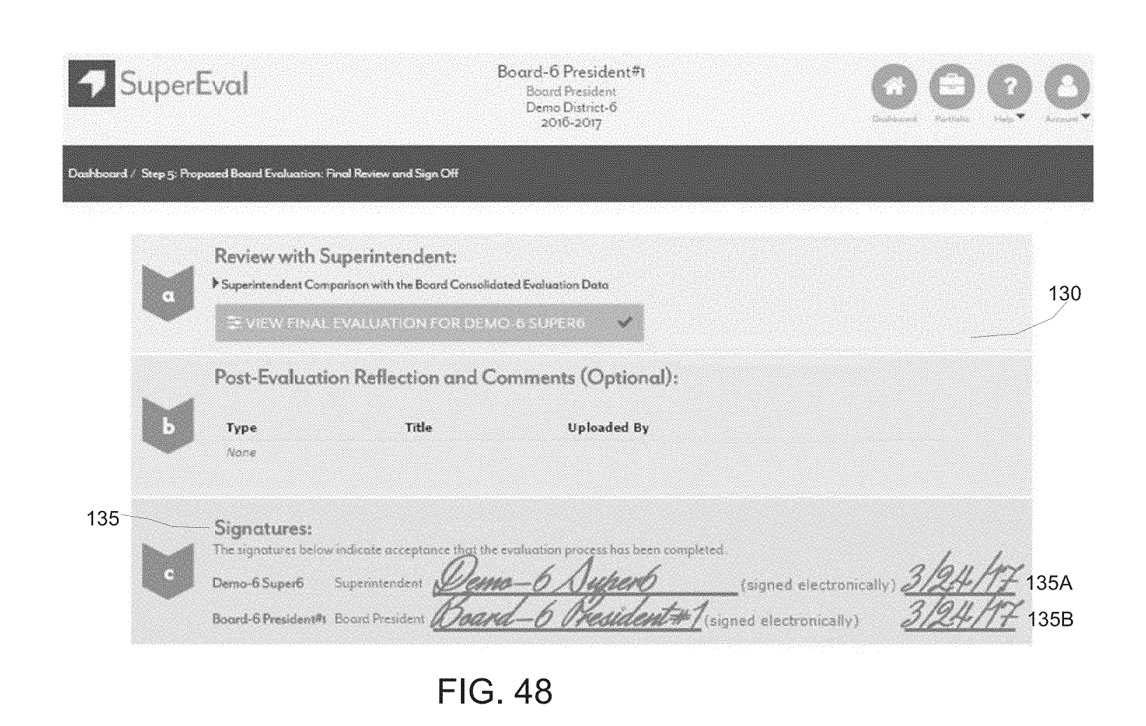

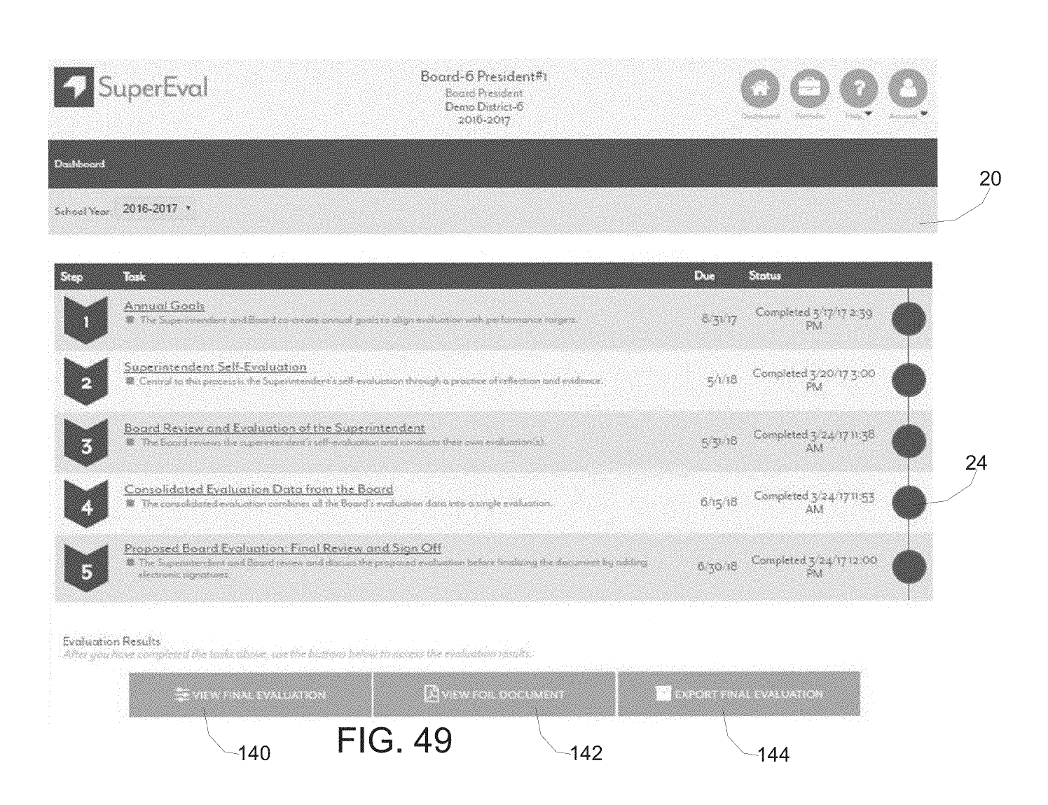

The proposed evaluation may be viewed by clicking a view button 131. Post-evaluation reflections and comments may be uploaded using a drag-and-drop box 132 onto which the user may drag and drop a file or files from the remote computer's local directory for upload, and/or an address box 133 for entry of a URL address of a webpage. A SUBMIT button 134 may be clicked for submitting the identified file(s) and/or URL address. Signatures may be provided electronically using a signature block 135 including a space 135A for the employee 6 to electronically sign and date the evaluation, and a space 135B for the group leader 4L to electronically sign and date the evaluation. FIG. 46 is a view similar to that of FIG. 45, wherein the employee 6 has signed the employee evaluation but the group leader 4L has not yet signed. In the view of FIG. 46, the group leader 4L is logged in. Therefore, a SIGN button 136 is associated with space 135B to execute the electronic signature. As may be understood, SIGN button 136 is associated with space 135A when employee 6 is logged in but has not yet signed the evaluation. FIG. 47 shows main dashboard screen 20 of the evaluation dashboard application after the employee 6 has signed the employee evaluation but before the group leader 4L has signed the employee evaluation. Because only one of the two signatories has signed, pie graph 24 and bar graph 27 corresponding to step five each indicate fifty-percent completion of the step. FIG. 48 is a view similar to that of FIG. 46, however group leader 4L has also signed the employee evaluation. Accordingly, when the user returns to main dashboard screen 20 shown in FIG. 49, pie graph 24 is completely shaded to indicate that step five is completed.

The evaluation dashboard application may provide various options for viewing and/or outputting the completed evaluation. For example, a VIEW FINAL EVALUATION button 140 may allow the user to view but not change or edit the final evaluation, a CREATE FOIL DOCUMENT 142 may allow the user to generate a report that is responsive to Freedom of Information Law requirements or similar legal requirements in a particular state or locality, and an ARCHIVE button 144 may allow the user to save the evaluation to an archive associated with the group and/or the employee.

As may be understood from the foregoing description, a computer-implemented method of conducting an evaluation of employee 6 is provided which solves a technical problem inherent in a paper-based process: that of keeping all participants in the process informed of the actual current status of the evaluation process on a collective basis without adding to the workload of any participant. In a paper-based evaluation process, only the employee will know the current progress status of an initial self-evaluation until the self-evaluation is completed and submitted to the group leader. Likewise, only an individual group member will know the progress status of his or her external-evaluation until the external-evaluation is completed and submitted to the group leader. Thus, the participants are unaware of where they stand relative to other participants as to progress in completing the evaluation. Prior to completion of the self-evaluation, the group leader will not know the progress of the employee without communicating with the employee. Similarly, prior to completion of an external-evaluation by a specific group member, the group leader will not know the progress of the group member without communicating with the group member. Consequently, significant added workload is involved in order for the group leader to become aware that intervention may be needed to urge participants to complete their respective evaluation tasks in a timely manner. Because a paper-based evaluation process centers around the group leader as a receiver of completed evaluation information from all participants, there is no way for a participant other than the group leader to know which other participants have completed the required evaluation except by communicating with the group leader or the group leader's staff, who must then review submissions and provide status information, thereby adding to workload. Due to other work duties, this time consuming task cannot be refreshed after every new completed evaluation is received.

The computer-implemented method described herein is more than simply automating a paper-based process. Specifically, the method comprises generating two different types of progress reports on demand: 1) a collective progress report indicating a proportion of group members who have transmitted external-evaluation information to the hub server at a time the collective progress report is generated, and 2) a plurality of individual progress reports respectively indicating a completeness of external-evaluation information received at the hub server from each of the plurality of group members at a time the plurality of individual progress reports are generated. The collective progress report and the individual progress reports keep all participants in the process informed of the actual current status of the evaluation process on a collective basis without adding to the workload of any participant. Consequently, the computer-implemented method described herein applies peer pressure on the participants to complete evaluation tasks, but it does so without burdening any of the participants or stressing working relationships among participants. In this way, the computer-implemented method does not merely automate a traditional paper-based process, it enhances the process itself to improve completion time.

While the evaluation method is described in the present specification with reference to a school board evaluation of a school district superintendent under a predefined rubric developed for this type of evaluation, the disclosed evaluation method is adaptable to other specific evaluation settings and other evaluation rubrics.

While the invention has been described in connection with exemplary embodiments, the detailed description is not intended to limit the scope of the invention to the particular forms set forth. The invention is intended to cover such alternatives, modifications and equivalents of the described embodiment as may be included within the scope of the invention.

What is claimed is:

1. A computer-implemented method of conducting an evaluation of an employee by a plurality of group members including a group leader, wherein the employee and the plurality of group members are participants, the method comprising the steps of:
providing an evaluation dashboard application to the participants for execution by each participant on one or more remote computers connected to a network;
providing a database server connected to the network, the database server comprising a microprocessor and a memory configured to store evaluation information associated with the evaluation of the employee and participant information respectively associated with the participants, wherein the participant information indicates a role of the associated participant chosen from the group of roles consisting of employee, regular group member, and group leader;
providing a hub server connected to the database server and the one or more remote computers via the network;
receiving employee performance self-evaluation information at the hub server from the employee, wherein the self-evaluation information is transmitted to the hub server by the employee executing the evaluation dashboard application on a remote computer, and the self-evaluation information is stored as evaluation information by the database server;
permitting each of the plurality of group members to access and review the self-evaluation information by executing the evaluation dashboard application on a remote computer;
receiving employee performance external-evaluation information at the hub server respectively from the plurality of group members, wherein the external-evaluation information is transmitted to the hub server by the plurality of group members, respectively, executing the evaluation dashboard application on a remote computer, and the external-evaluation information is stored as evaluation information by the database server;
generating a collective progress report in the evaluation dashboard application, wherein the collective progress report indicates a proportion of group members who have transmitted external-evaluation information to the hub server at a time the collective progress report is generated; and
generating a plurality of individual progress reports in the evaluation dashboard application, wherein the plurality of individual progress reports respectively indicate a completeness of external-evaluation information received at the hub server from each of the plurality of group members at a time the plurality of individual progress reports are generated;
wherein the collective progress report and the plurality of individual progress reports are accessible by each participant executing the evaluation dashboard application on a remote computer without communicating with another participant.

2. The method according to claim 1, wherein the step of receiving employee performance self-evaluation information at the hub server from the employee, and the step of receiving employee performance external-evaluation information at the hub server respectively from the plurality of group members, are sequential workflow steps in a workflow guided by the evaluation dashboard application, and wherein the collective progress report indicates a due date for each of the workflow steps.

3. The method according to claim 1, further comprising the step of providing a prepopulation option enabling each of the plurality of group members to automatically prepopulate external-evaluation information to be transmitted to the hub server with received self-evaluation information without communicating with the employee.

4. The method according to claim 1, wherein the evaluation information is organized under an evaluation rubric comprising a plurality of competency domains, each of the plurality of competency domains including at least one specified competency.

5. The method according to claim 4, further comprising the steps of:
receiving at least one employee performance goal at the hub server from the employee, wherein the at least one employee performance goal is transmitted to the hub server by the employee executing the evaluation dashboard application on a remote computer;
appending a further competency domain to the evaluation rubric; and
allocating the at least one employee performance goal to the further competency domain.

6. The method according to claim 4, wherein the self-evaluation information includes a self-grade and a self-reflection for each of the specified competencies within the evaluation rubric.

7. The method according to claim 6, wherein the self-evaluation information further includes evidence associated with at least one of the specified competencies within the evaluation rubric.

8. The method according to claim 4, wherein the external-evaluation information includes a grade and a comment for each of the specified competencies within the evaluation rubric.

9. The method according to claim 8, wherein the external-evaluation information further includes evidence associated with at least one of the specified competencies within the evaluation rubric.

10. The method according to claim 8, wherein the collective progress report indicates a proportion of group members who have completed transmitting external-evaluation information to the hub server, a proportion of group members who have started but not completed transmitting external-evaluation information to the hub server, and a proportion of group members who have not started transmitting external-evaluation information to the hub server.

11. The method according to claim 10, wherein the collective progress report includes a bar graph.

12. The method according to claim 11, wherein the bar graph is displayed on a main dashboard screen of the evaluation dashboard application when the evaluation dashboard application is executed on a remote computer.

13. The method according to claim 8, wherein each of the plurality of individual progress reports indicates a proportion of the total number of competencies within the evaluation rubric for which external-evaluation information has been received.

14. The method according to claim 13, wherein each of the plurality of individual progress reports includes a bar graph.

15. The method according to claim 14, wherein each bar graph is displayed on a secondary screen of the evaluation dashboard application when the evaluation dashboard application is executed on a remote computer.
